(19) United States
(12) Patent Application Publication
(10) Pub. No.: US 2016/0283470 A1
(43) Pub. Date: Sep. 29, 2016

(54) SYSTEM AND METHOD FOR IDENTIFYING, ORGANIZING, AND PRESENTING MEDIA NEWS AND EVENT CONTENT WITH OPPOSING BIAS

(71) Applicants: Gary B. Solomon, Dallas, TX (US); Mark B. Solomon, Dallas, TX (US)

(72) Inventors: Gary B. Solomon, Dallas, TX (US); Mark B. Solomon, Dallas, TX (US)

(21) Appl. No.: 14/931,555

(22) Filed: Nov. 3, 2015

Related U.S. Application Data
(60) Provisional application No. 62/074,169, filed on Nov. 3, 2014.
(60) Provisional application No. 62/155,303, filed on Apr. 30, 2015.
(60) Provisional application No. 62/192,419, filed on Jul. 14, 2015.

(51) Int. Cl. G06F 17/30; G06Q 50/26; G06F 17/21

(52) U.S. Cl. CPC G06F 17/3005; G06F 17/211; G06F 17/30038; G06Q 50/26

(57) ABSTRACT

A system and method of providing users with organized content based on bias and other factors.

### CROSS-REFERENCE TO RELATED APPLICATIONS

This application claims the benefit of priority to U.S. Provisional Application Ser. No. 62/074,169, filed Nov. 3, 2014, U.S. Provisional Application Ser. No. 62/155,303, filed Apr. 30, 2015, and U.S. Provisional Application Ser. No. 62/192,419, filed Jul. 14, 2015, the contents of which are hereby incorporated by reference.

### BACKGROUND

Media had traditionally been the “watchdog” of government, which, in part, is a reason why the framers of the United States Constitution included the First Amendment that provides for freedom of speech. While the media historically had conducted itself in a manner that operated to keep the government in check, the media these days has been overtly biased either to the “left” (i.e., liberal) or the “right” (i.e., conservative). The polarization of the media in either direction tends to draw audiences that respectively lean “left” or “right.” However, there is a very large segment of the population that is either neutral or wants less biased media, not only for reading purposes, but also for constitutional purposes.

The media, despite claiming in some instances to be balanced and unbiased, is well known by professionals and consumer viewers that a bias exists. And, these media outlets come in all forms, including print, radio, online, television, and cable. In being biased, a story about a particular topic will include certain facts on one side, while omitting or skewing the facts on the other side. In general, each political side uses data and language to “slant” an audience's bias toward whichever side is being favored. As a result, the audience segment that does not want a biased media ignores the media altogether or follows the media, but maintains a high level of skepticism or distrust as a result of the media bias. In many cases, those looking for the truth look at multiple media sources, which is inconvenient and time consuming, especially if looking for stories about the same subject and topic.

While politics is an obvious topic that presents media bias, other topics also draw media bias. For example, topics, such as sports, conflicts between countries and/or religions, political campaigns, legal court cases, environmental issues, companies, celebrities (e.g., movie stars, athletes, etc.), and so on, are also topics that often present media bias. With each of the non-limiting examples, media biases are sometimes expected and even desired by audiences when media in a particular geographic region, such as a city, supports a sports team or other local topic.

### SUMMARY

To provide consumers with an impartial biased media platform, the principles of the present invention provide for a media platform that provides for a user interface accessible via a communications network that provides access (e.g., hyperlink or other reference tag) to multiple content (e.g., news stories) with opposing bias and having common topics and subjects in physical association with one another. That is, first content has a first bias and a second content has a second bias toward a subject of a story. In one embodiment, the access to the first and second content may be presented on left and right sides of the user interface. In the case of a political subject and topic, the content access positioned on a left side of the user interface may have a liberal bias, while the content access positioned on a right side of the user interface may have a conservative bias.

In establishing the access to the content, the principles of the present invention may present an aggregation and editing system that includes a user interface with content links and/or content with each bias in respective portions of the user interface. For example, the user interface may be a user interface configured for an editor to select content for display to an audience of the user interface that enables the editor to view a selectable set of content links with a first bias and with a second bias, thereby enabling the user editor to select which of the content with the first and second biases to be displayed to an audience of the content. That is, the editor may select one or more stories with opposing bias to present to an audience in opposition to one another (e.g., liberal bias on a left side and conservative bias on a right side of a user interface). More particularly, the principles of the present invention may provide an editing system that may be configured to automatically select content, such as news stories, of a particular topic and subject having a first bias and content with the same particular topic and subject having a second bias. In automatically selecting the news stories, an ontology model may be utilized to search through content that has the same topics and subjects, but having opposing biases. Alternatively, the editing system may automatically search for and identify content having a first bias and a second bias, and present a headline and/or other information indicative of the content. Indicator(s) as to topic, subject, and bias associated with each content may be displayed in relation with the content. Additionally, the editing system may be configured to generate source and author identifiers of each content for presentment to an audience.

### BRIEF DESCRIPTION

A more complete understanding of the method and apparatus of the present invention may be obtained by reference to the following Detailed Description when taken in conjunction with the accompanying Drawings wherein:

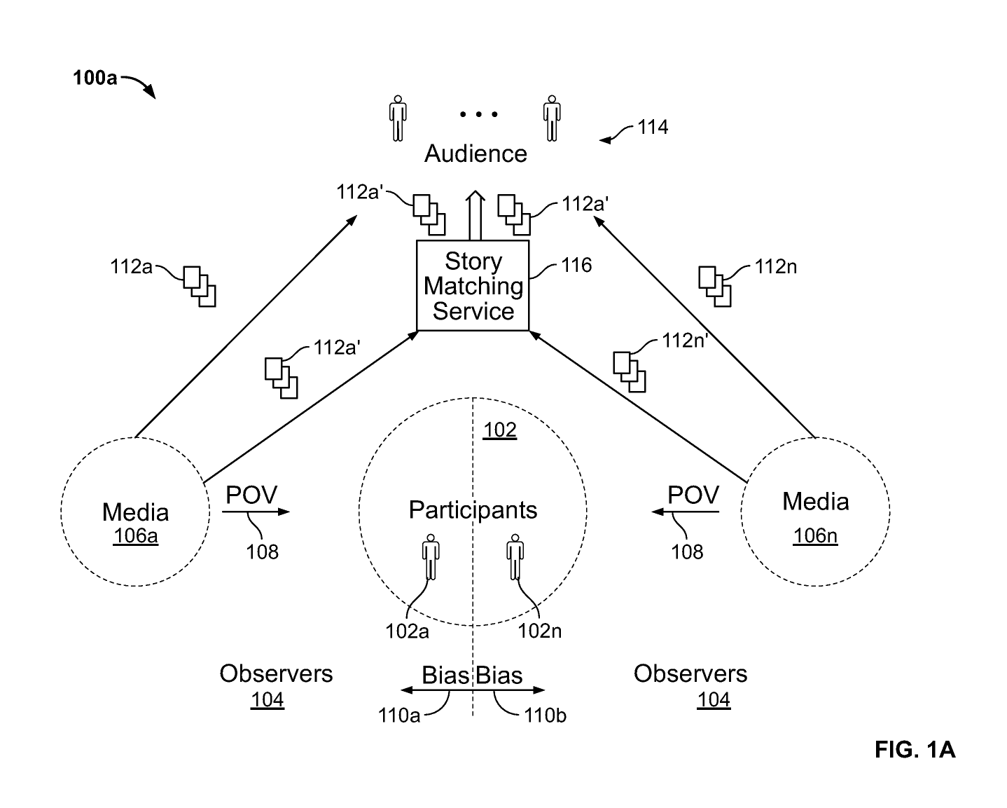

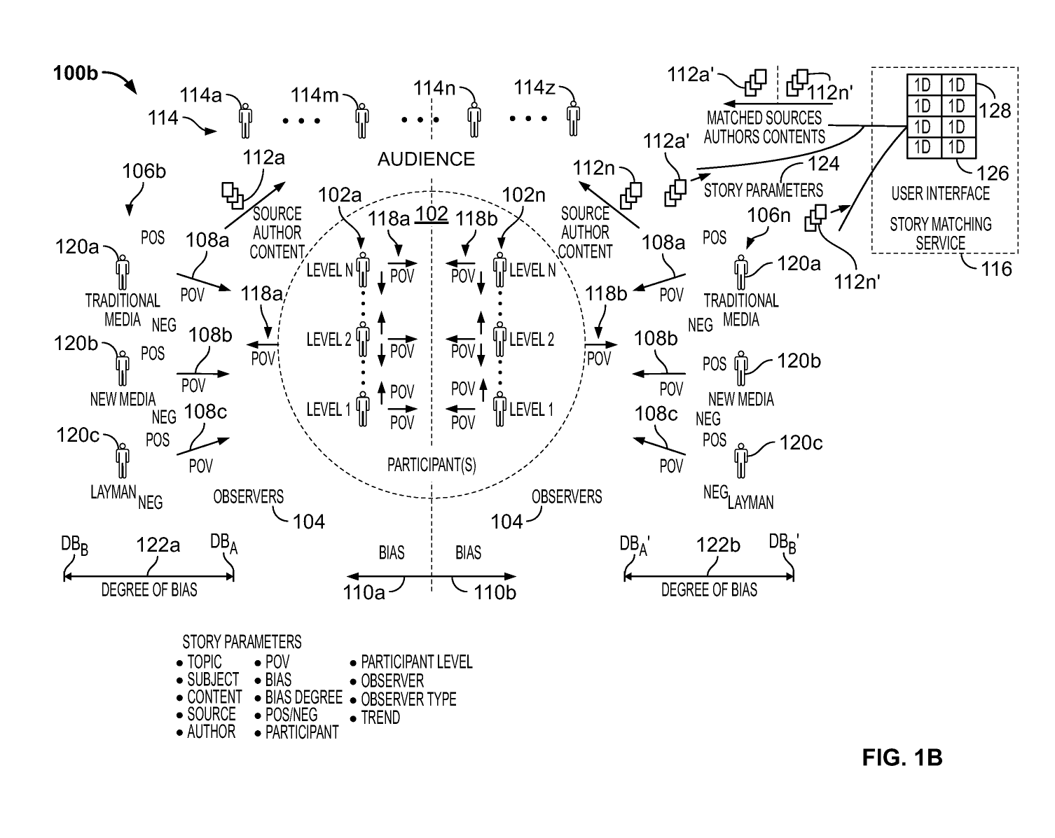

FIG. 1A is an illustration of an illustrative news environment in which participants may be the subject of a news story created by observers;

FIG. 1B is an illustration of a more detailed illustrative news environment of the news environment of FIG. 1A in which participants may be the subject of a news story created by observers;

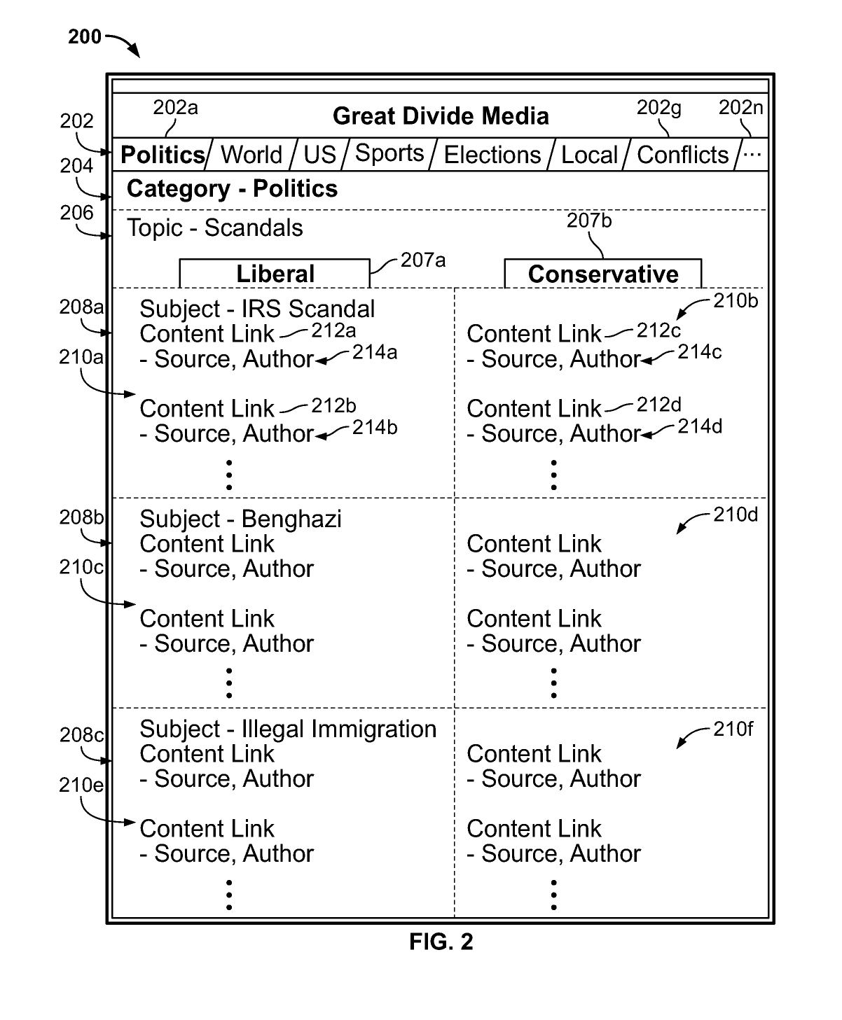

FIG. 2 is a screenshot of an illustrative user interface that provides for media content to be presented to a user in an organized manner, such as separating the content according to bias;

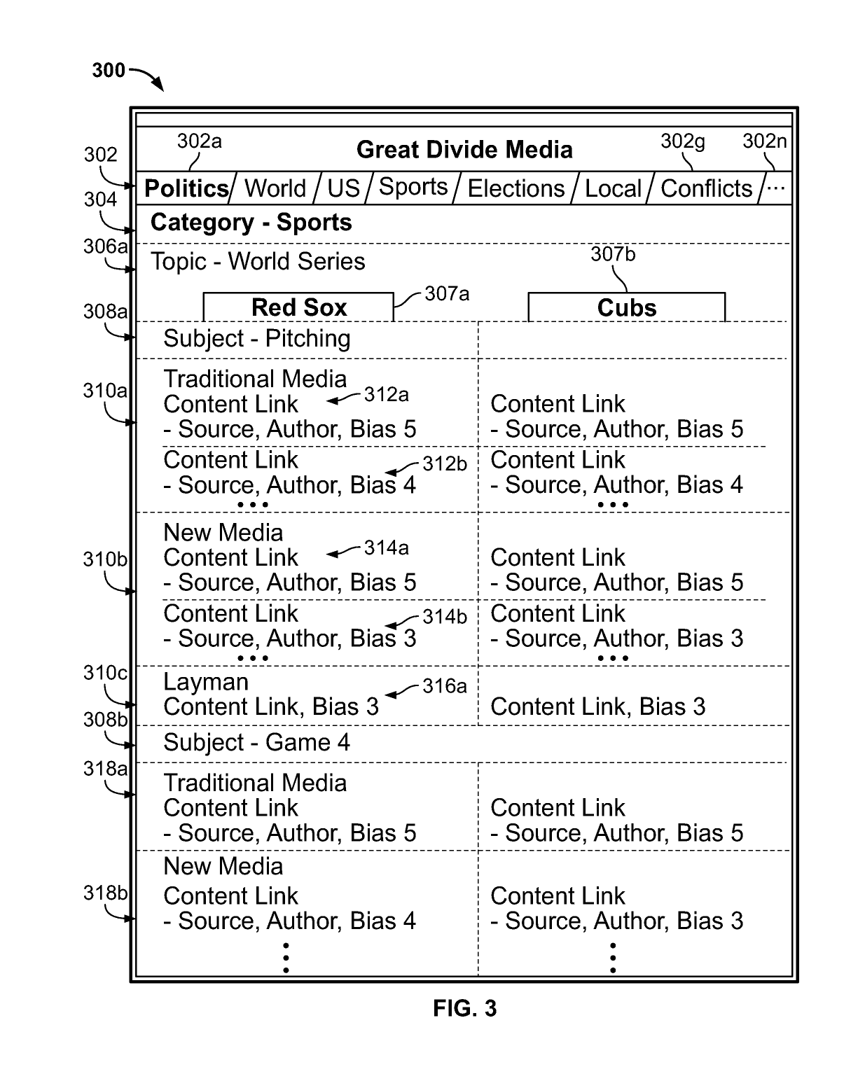

FIG. 3 is a screenshot of an illustrative user interface that provides for media content to be presented to a user in an organized manner, such as separating the content according to bias, along with matching media types and bias degrees;

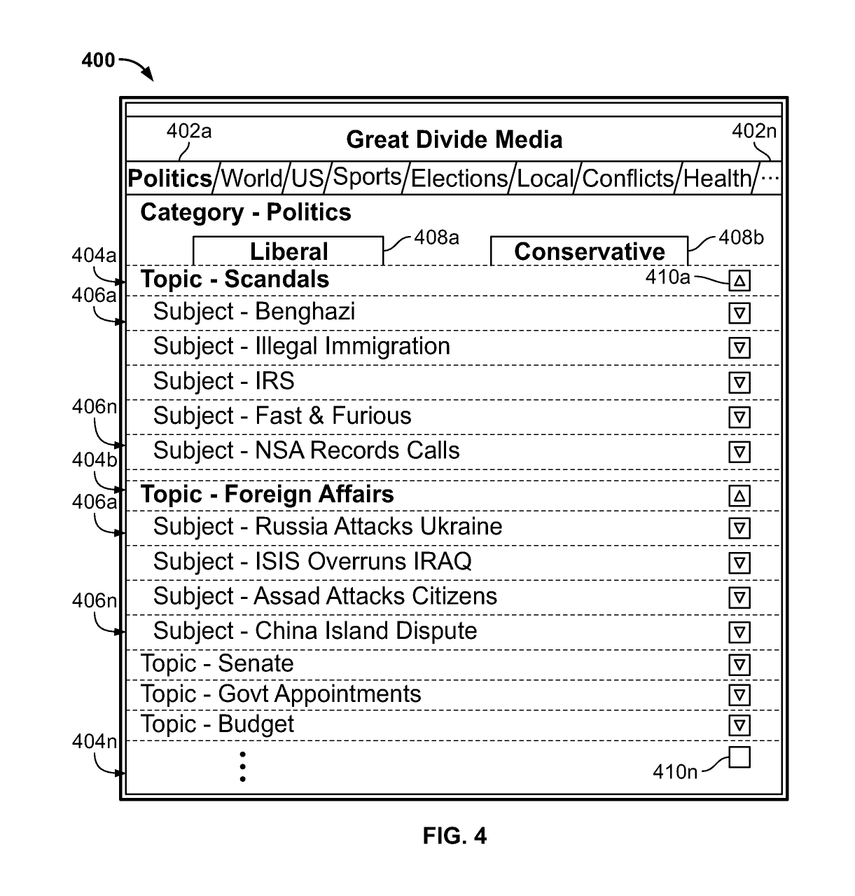

FIG. 4 is a screenshot of an illustrative user interface that provides for an alternative view of organizing opposing biased media content to be presented to a user in an organized manner using a hierarchical structure;

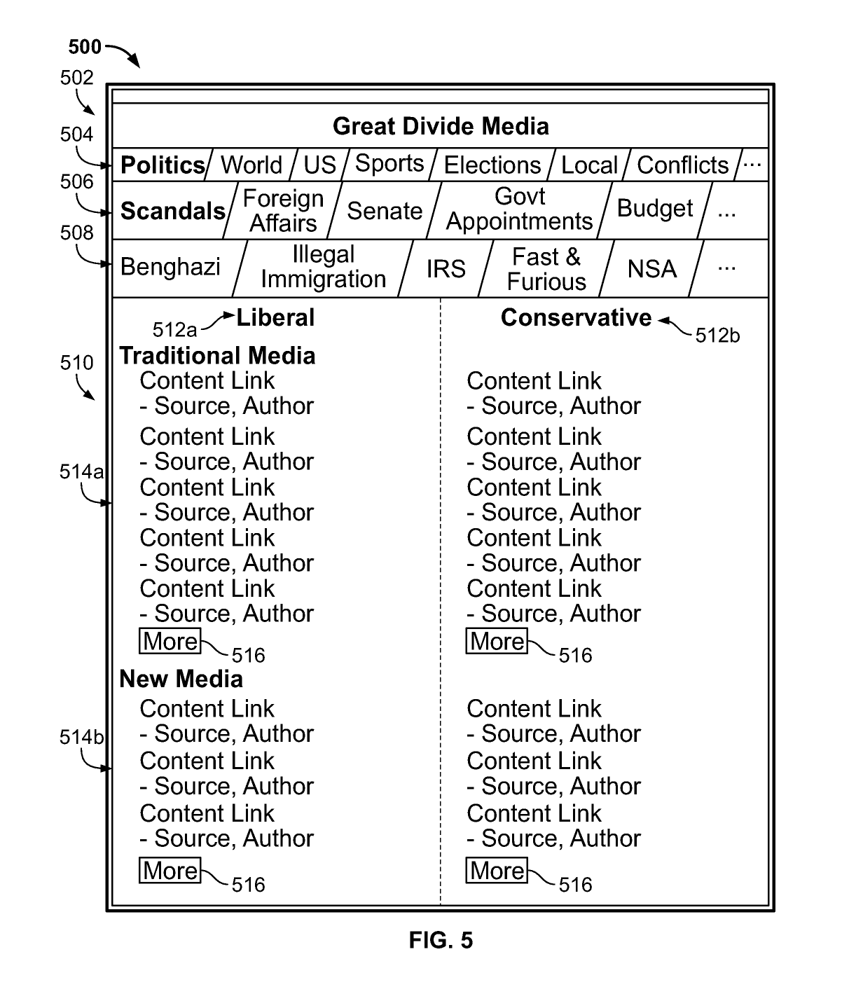

FIG. 5 is another screenshot of an illustrative user interface that provides for another alternative view of organizing opposing biased media content to be presented to a user in an organized manner using a hierarchical tab structure to easily enable users to “drill down” from categories to topics to subjects of information that he or she desires to view;

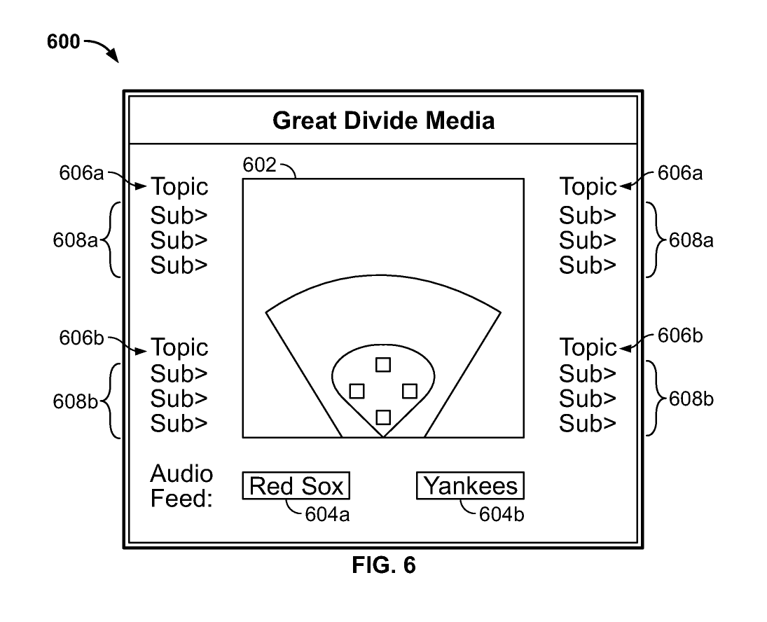

FIG. 6, a screen shot of an illustrative user interface in which a video or graphical image is displayed, in this case a sporting event (e.g., baseball game);

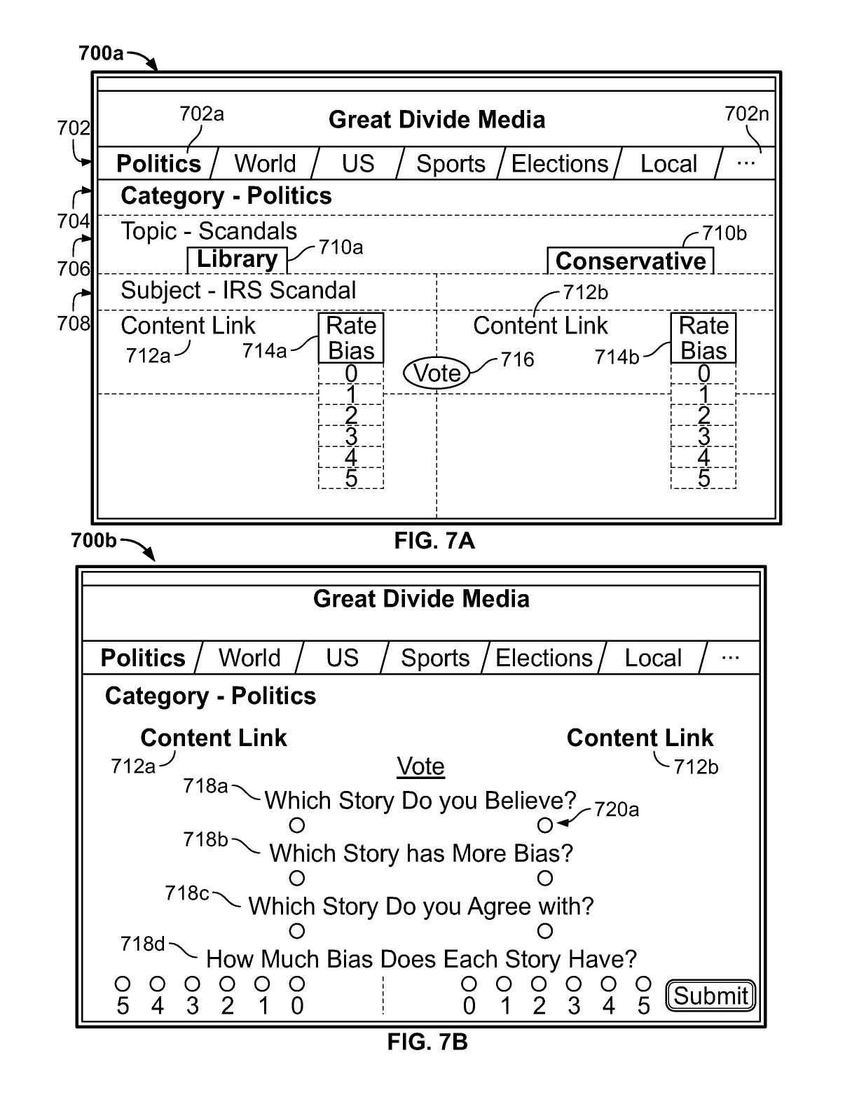

FIG. 7A is a screen shot of an illustrative user interface is shown to include a set of category tabs inclusive of selectable categories;

FIG. 7B is a user interface that may display content links or indicia, such as headlines, images, etc., associated with the respective content links along with illustrative questions of which a user may answer to rate or otherwise provide user-submitted information or feedback associated with the content link;

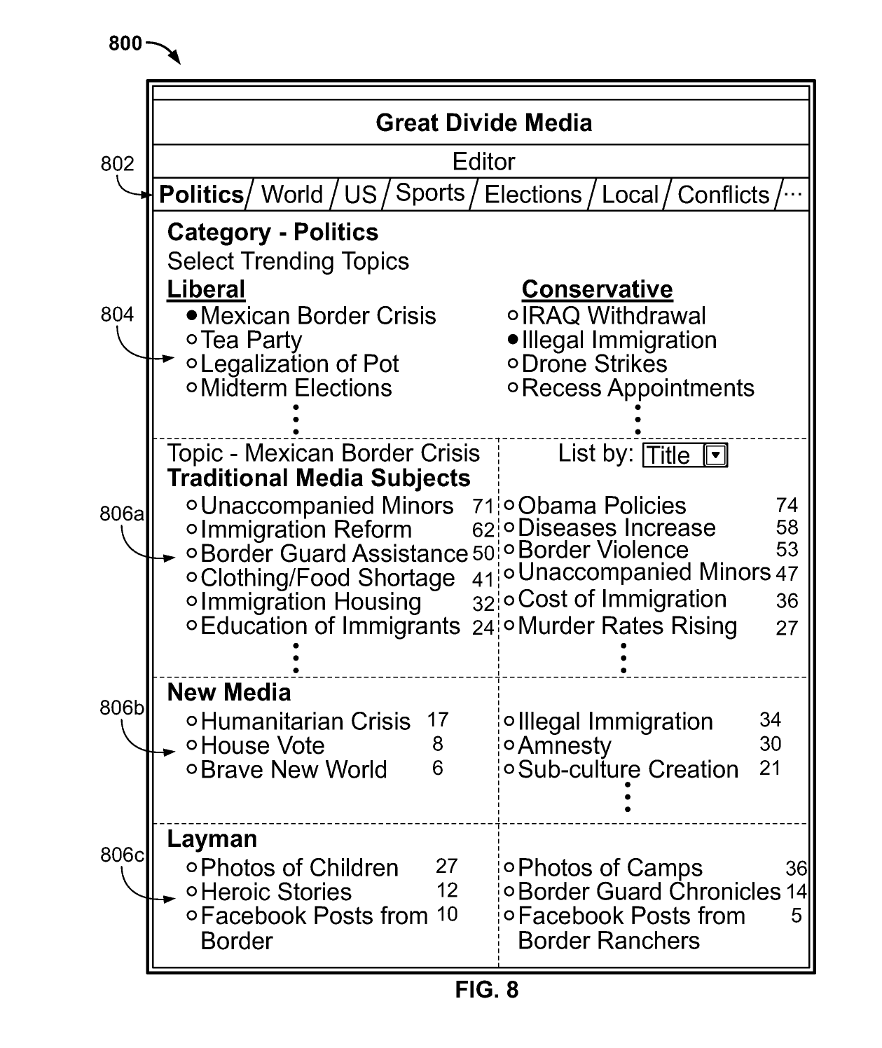

FIG. 8 is a screen shot of an illustrative user interface that provides for an editor to select categories, topics, and subjects along biases, such as liberal and conservative;

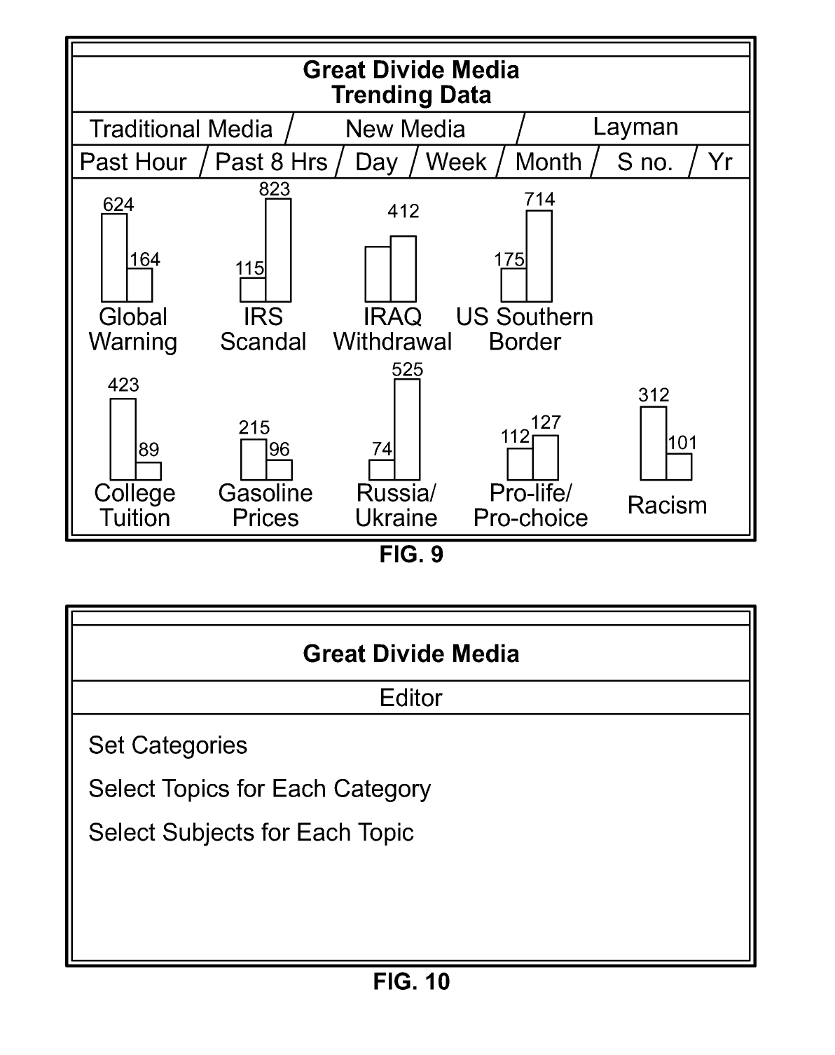

FIG. 9 is a screen shot of illustrative trending data that allows for an editor and/or user to view how certain news stories (or other types of events and issues) are trending;

FIG. 10 is a screen shot of an illustrative editor user interface that allows for an editor to select and set and create information to be displayed for users to view;

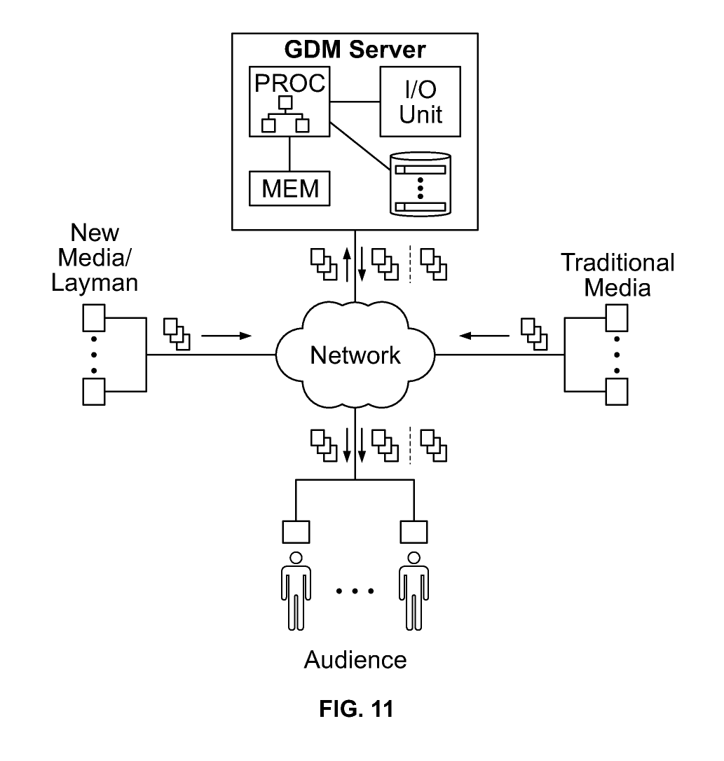

FIG. 11 is a network environment in which information may be collected and distributed to an audience;

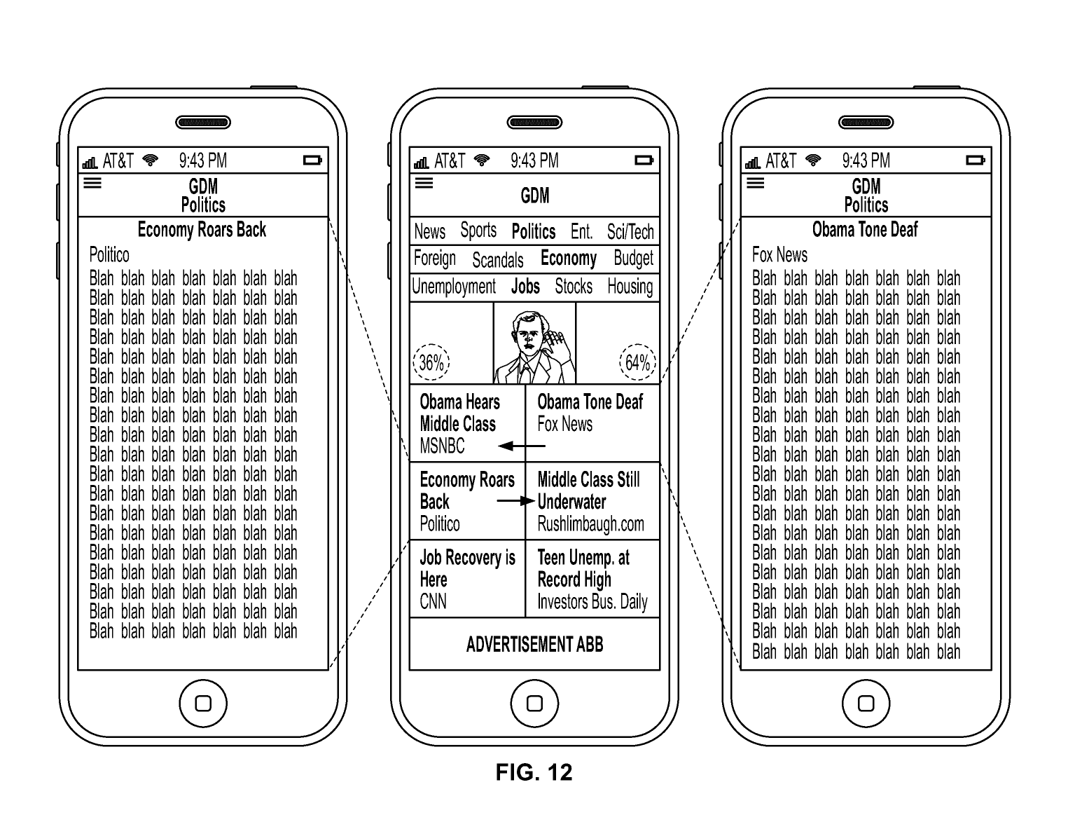

FIG. 12 are screenshots an illustrative user interfaces utilized on a mobile device to present information, such as headlines, associated with news stories (or other content) for a user selectably read content of the news stories by selecting (e.g., sliding) a headline of respective information;

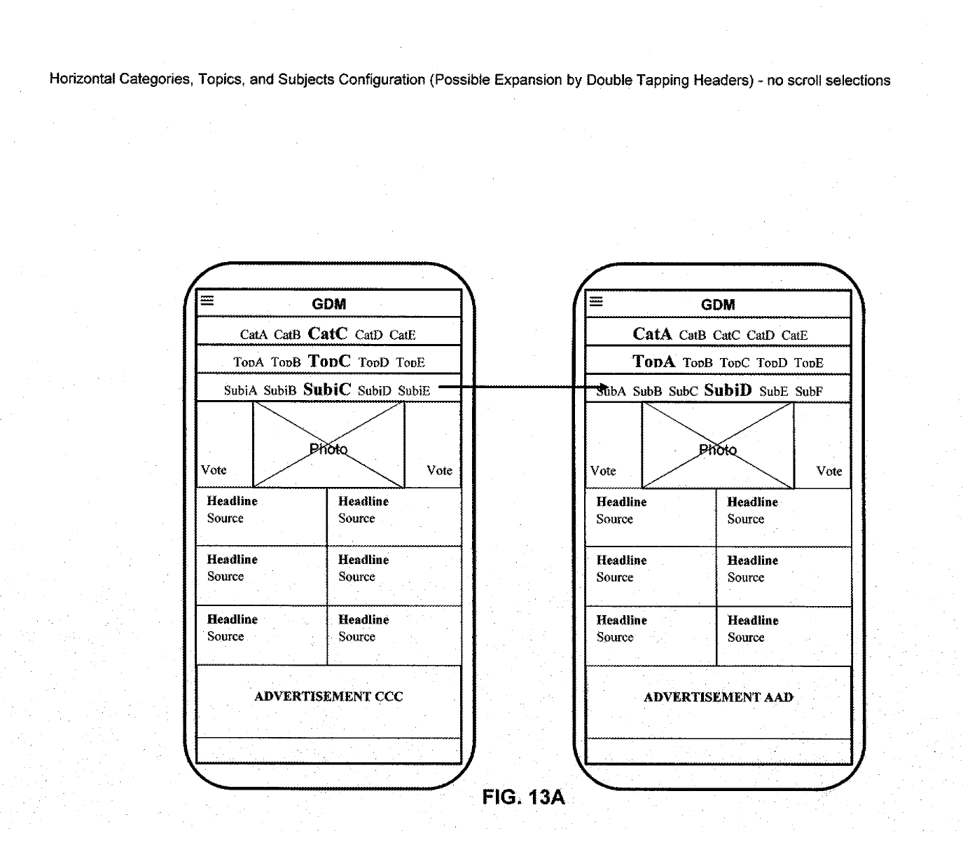

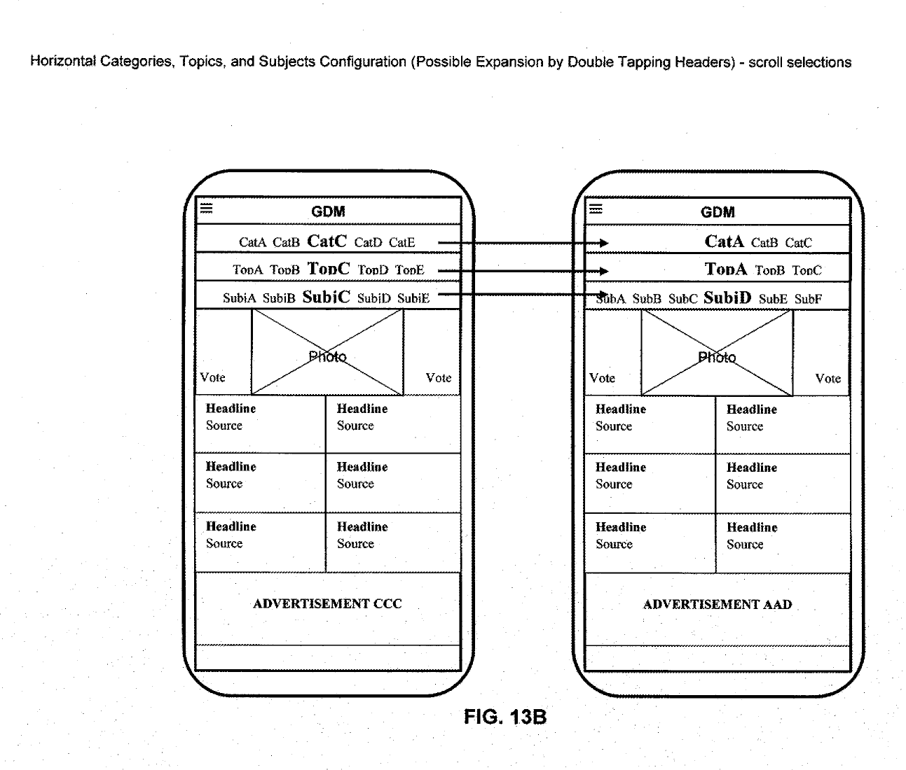

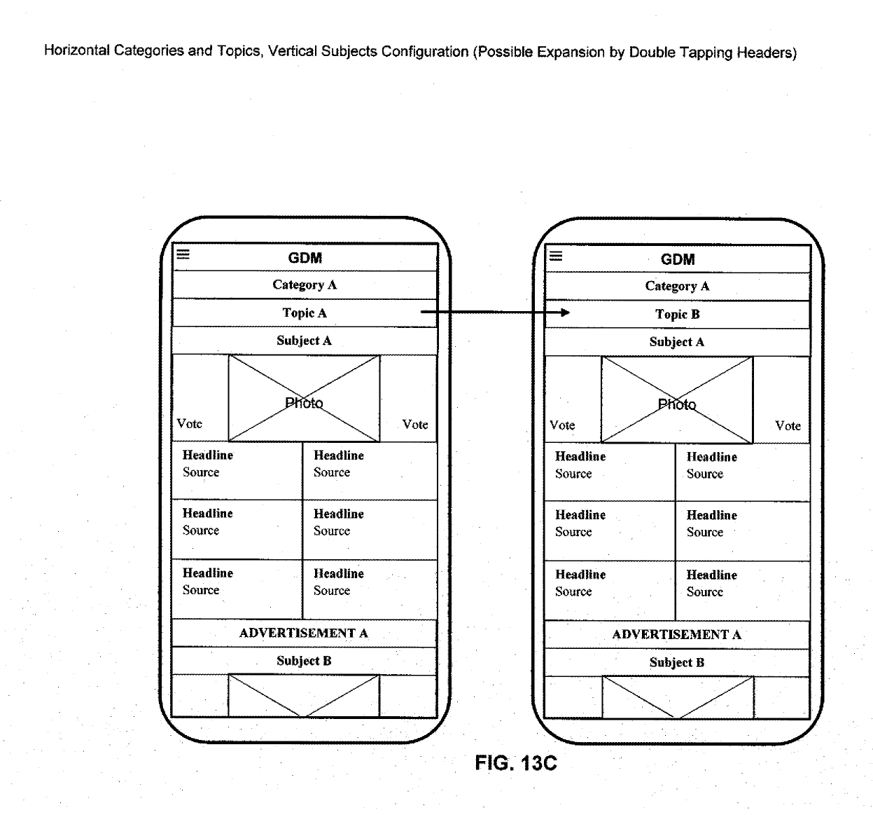

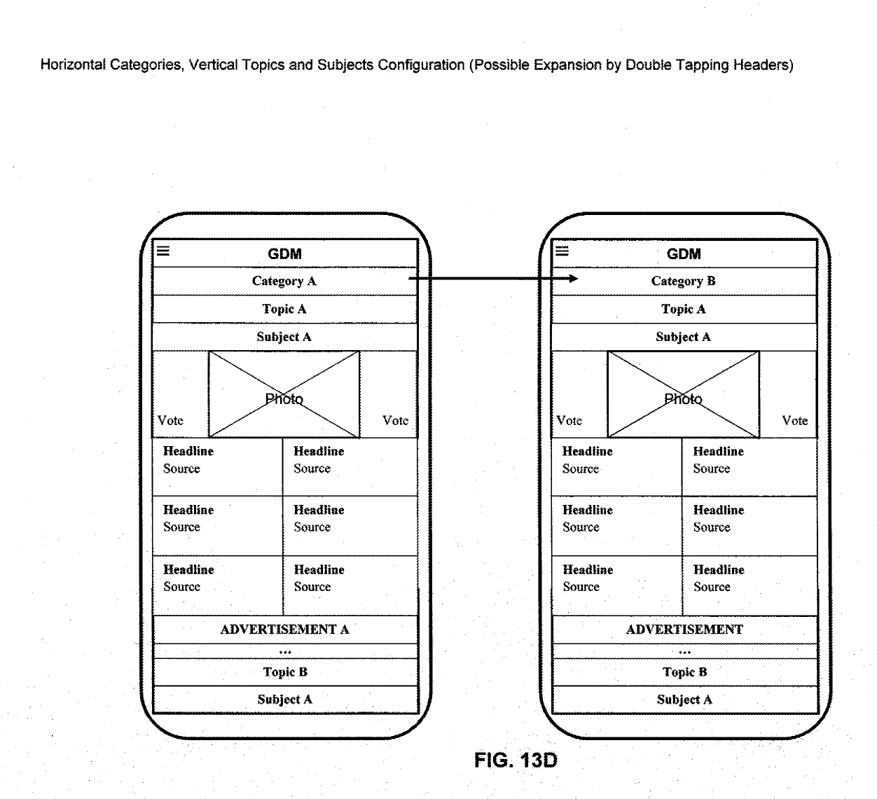

FIGS. 13A-13D are screenshots of illustrative alternative configurations of user interfaces utilized on a mobile device; and

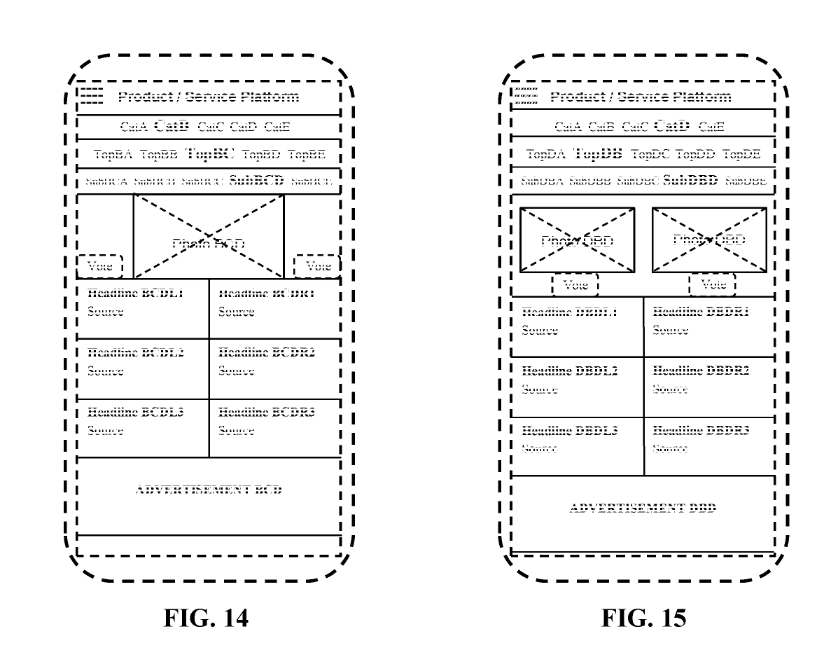

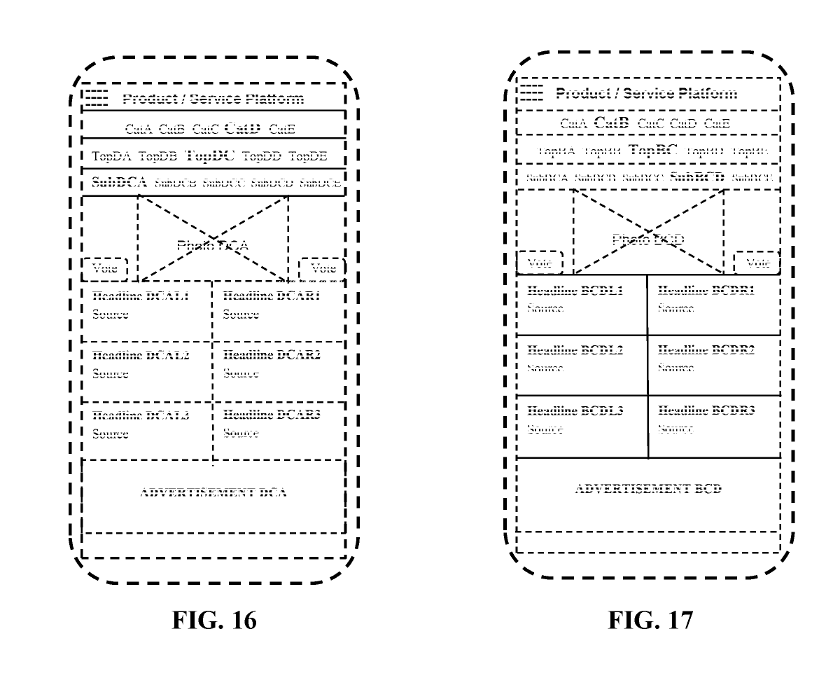

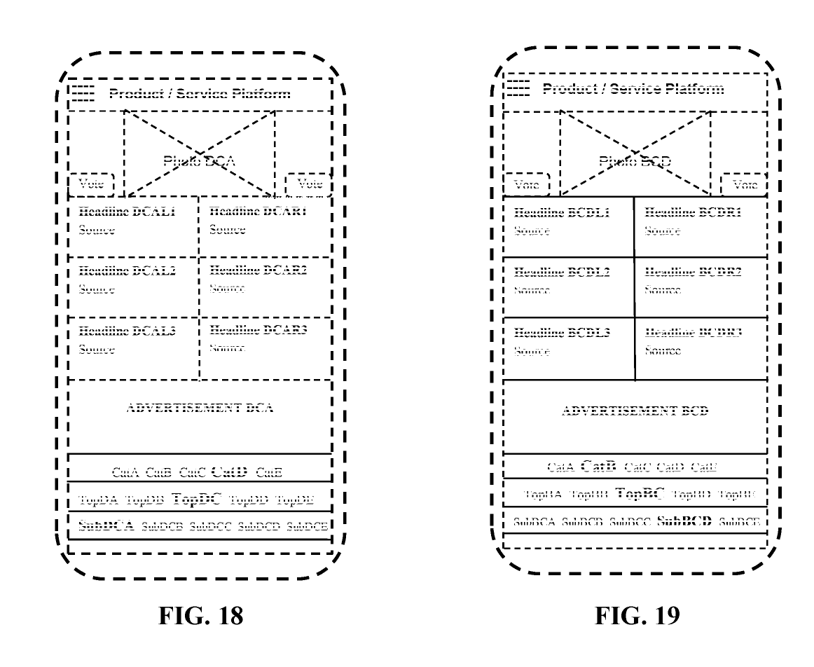

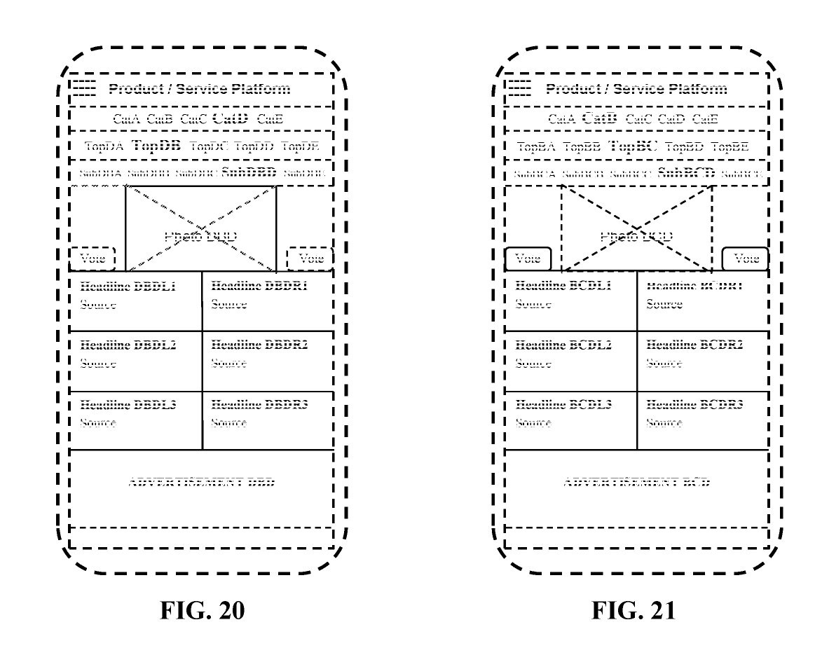

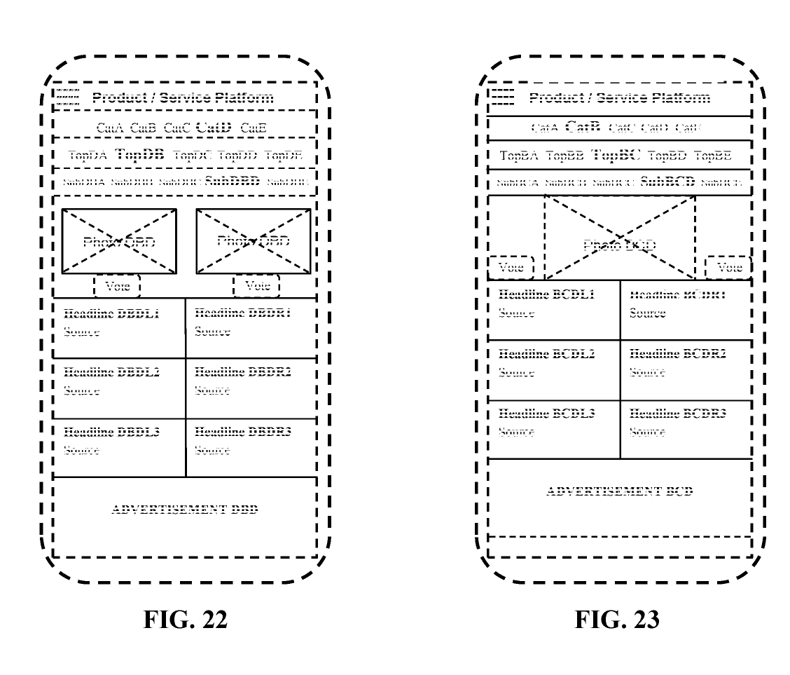

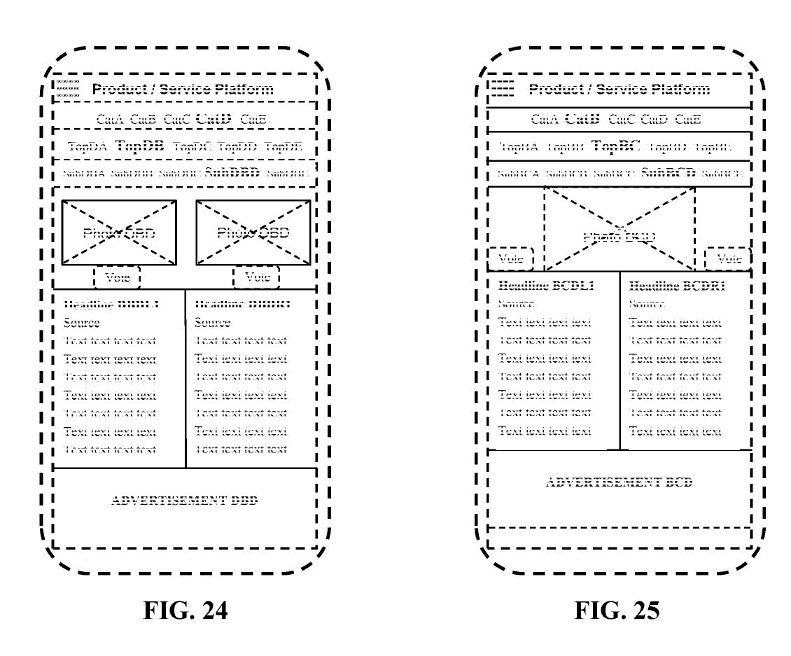

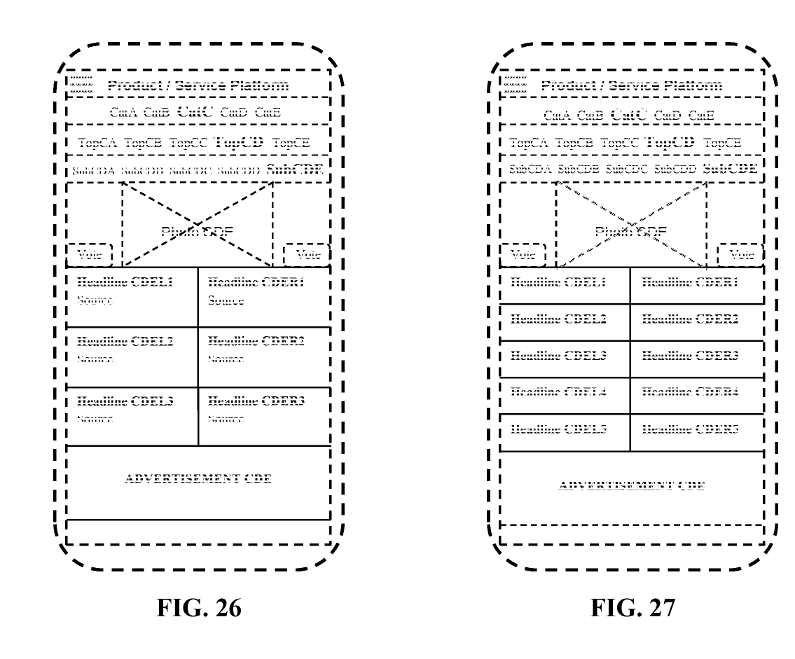

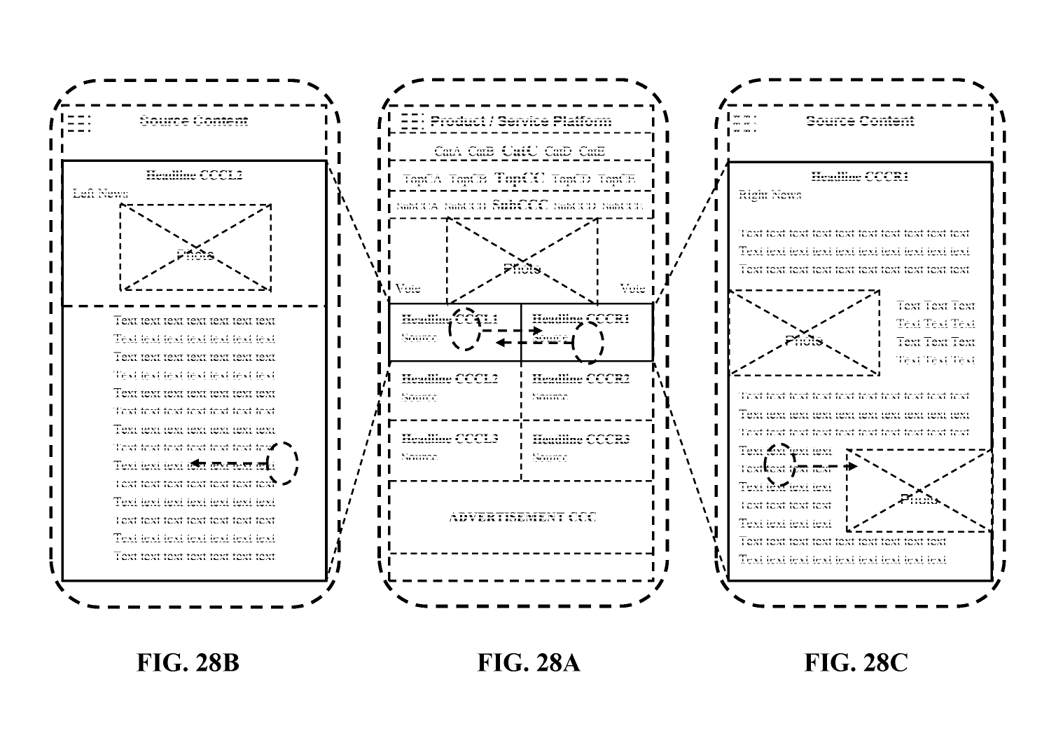

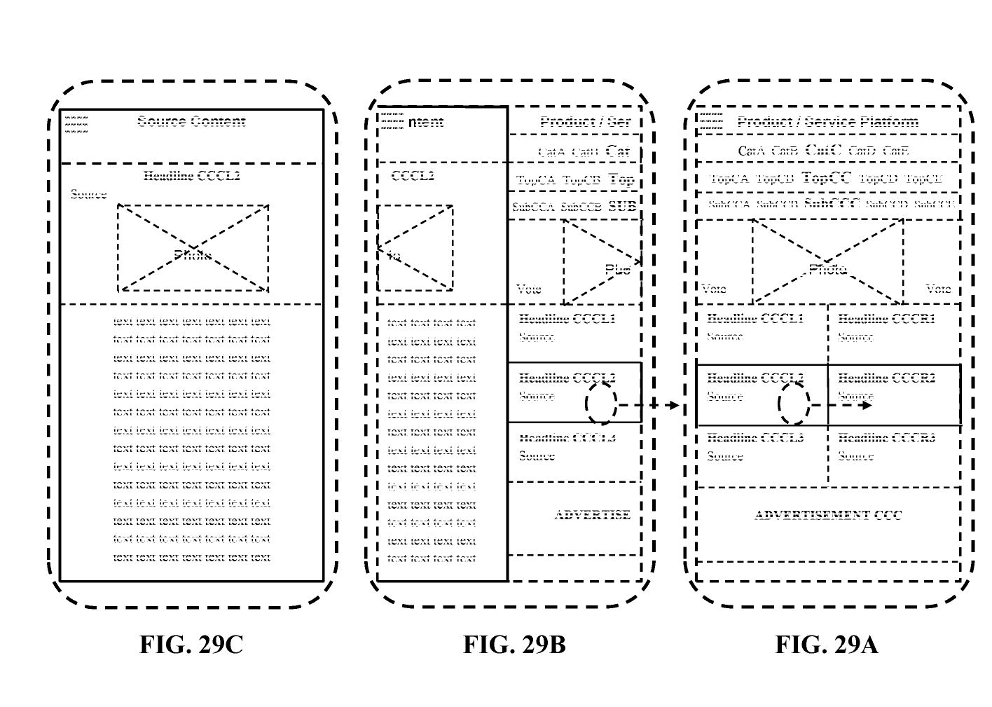

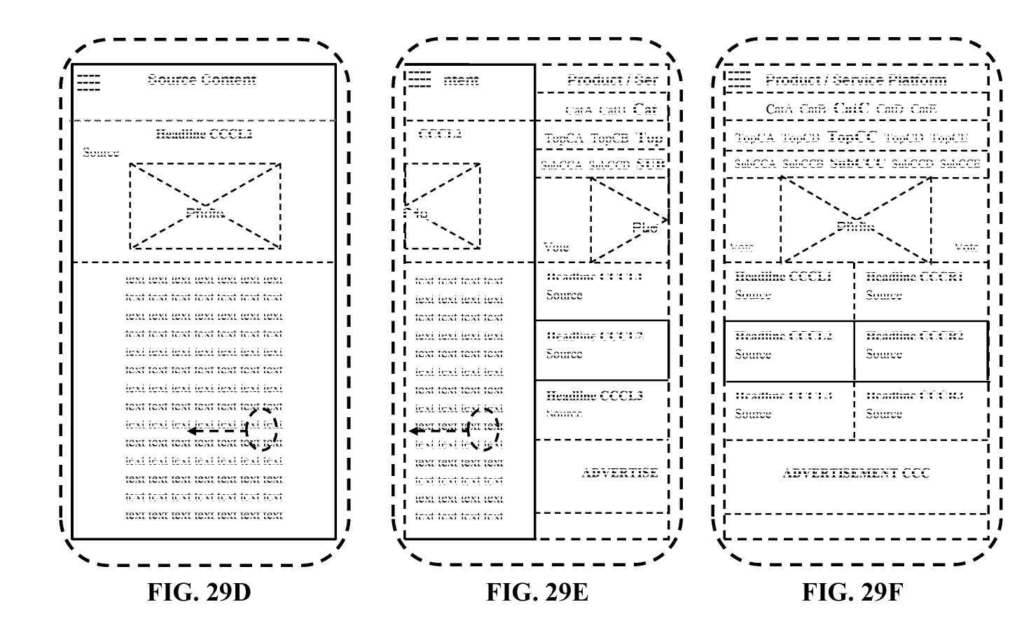

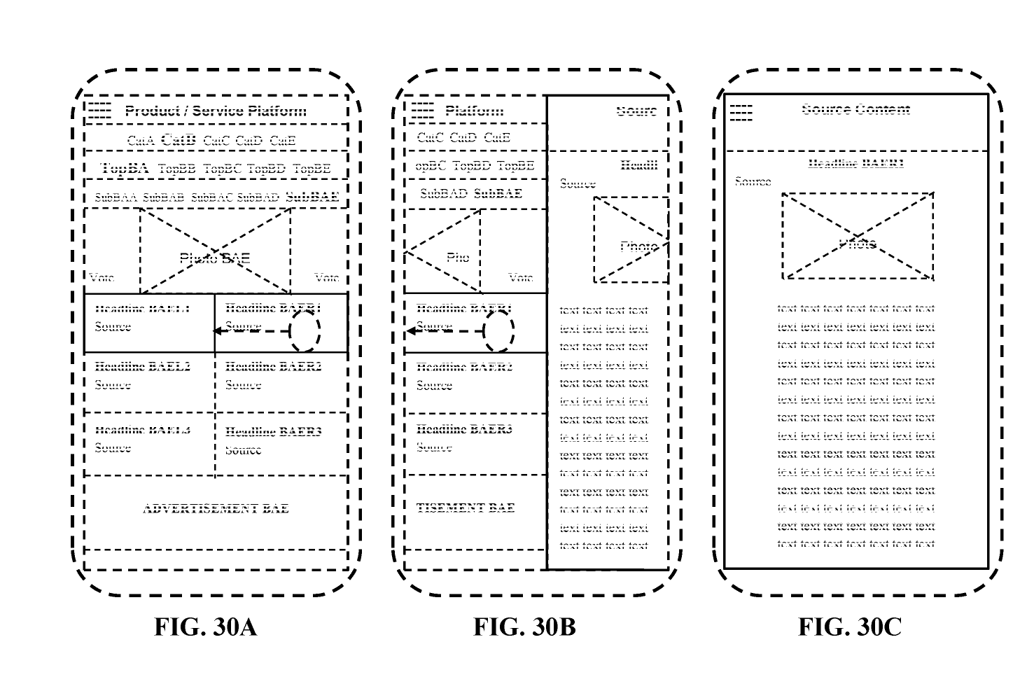

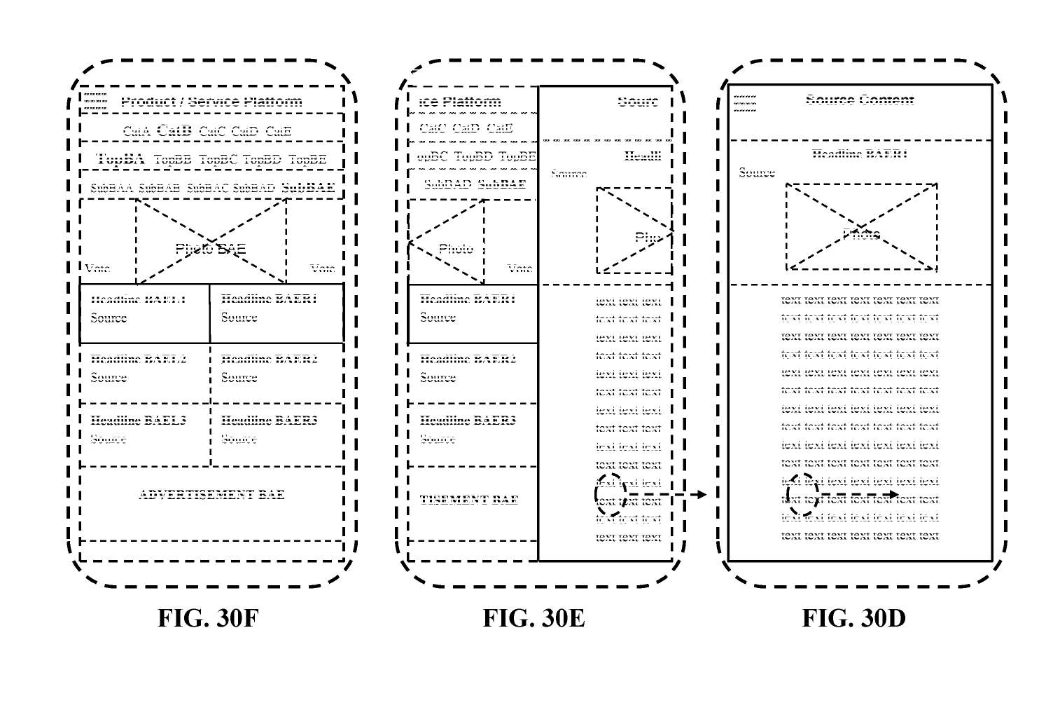

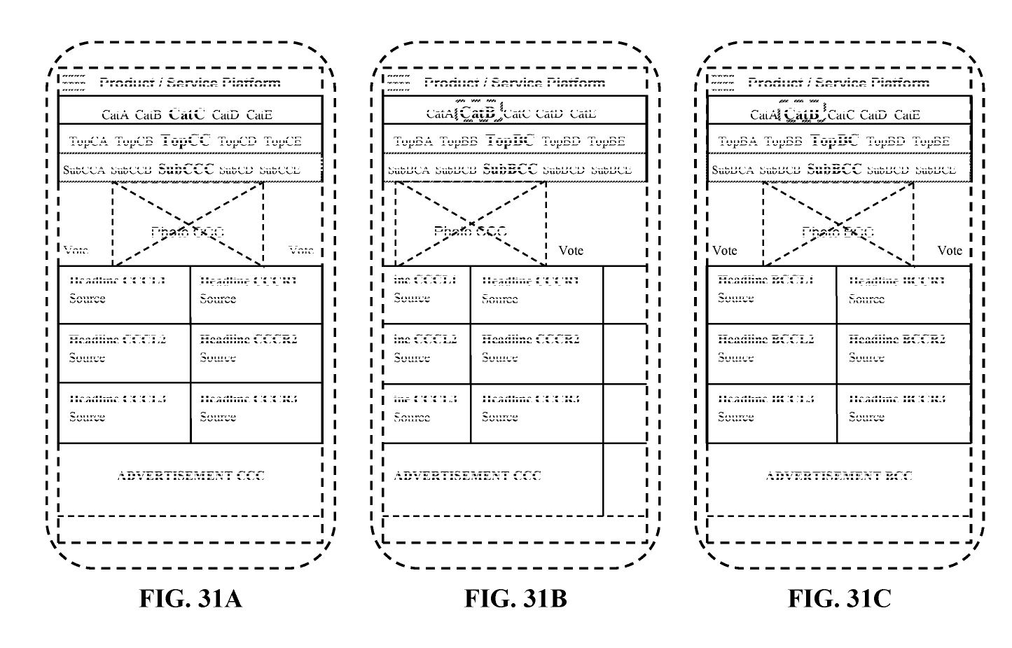

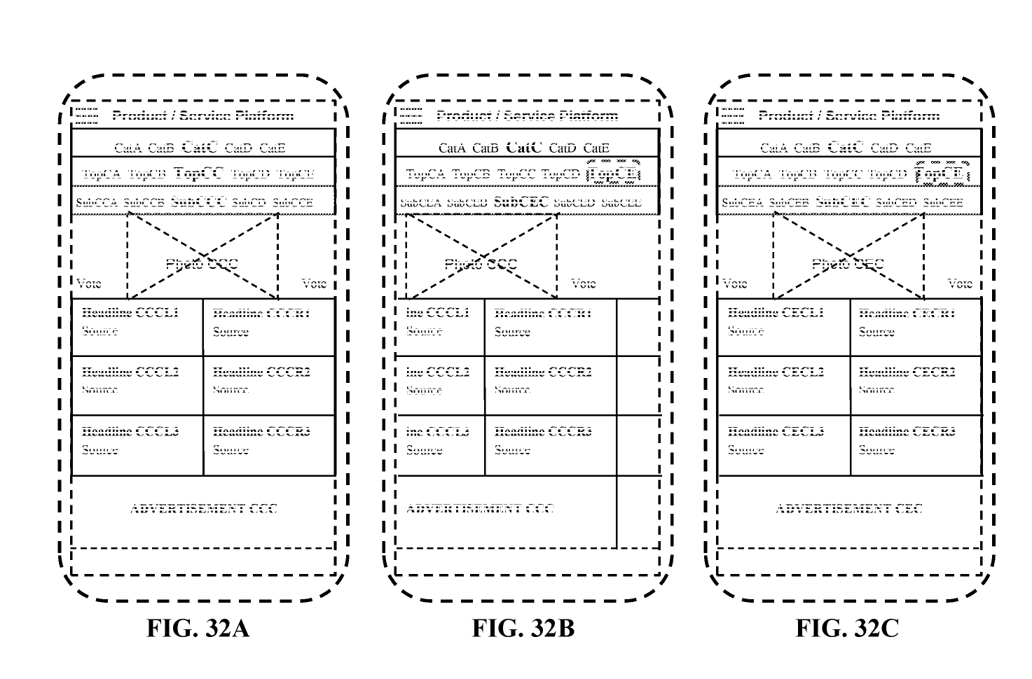

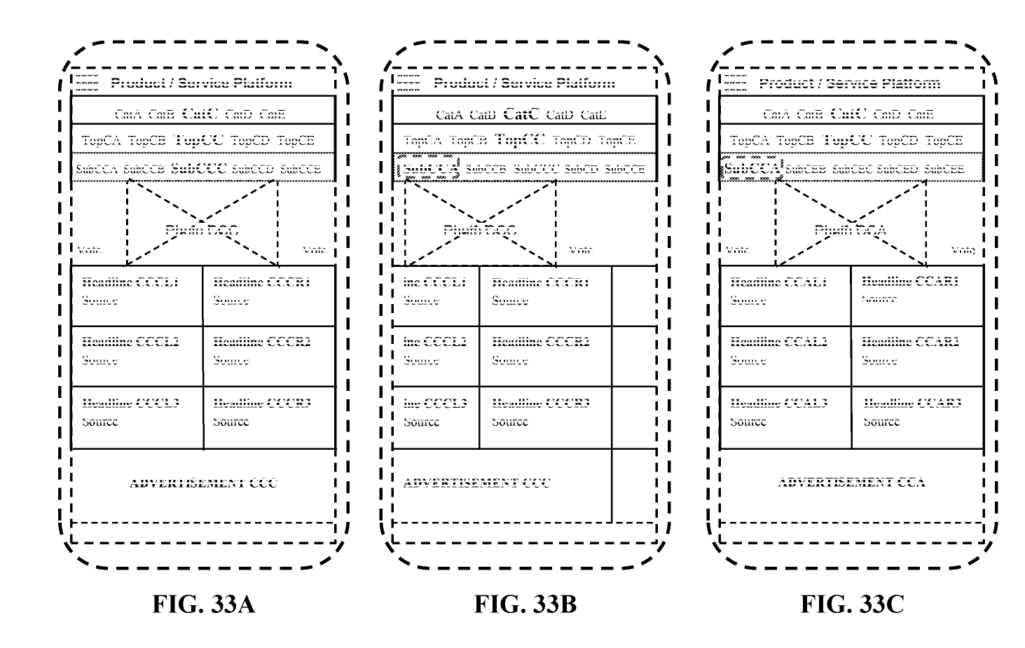

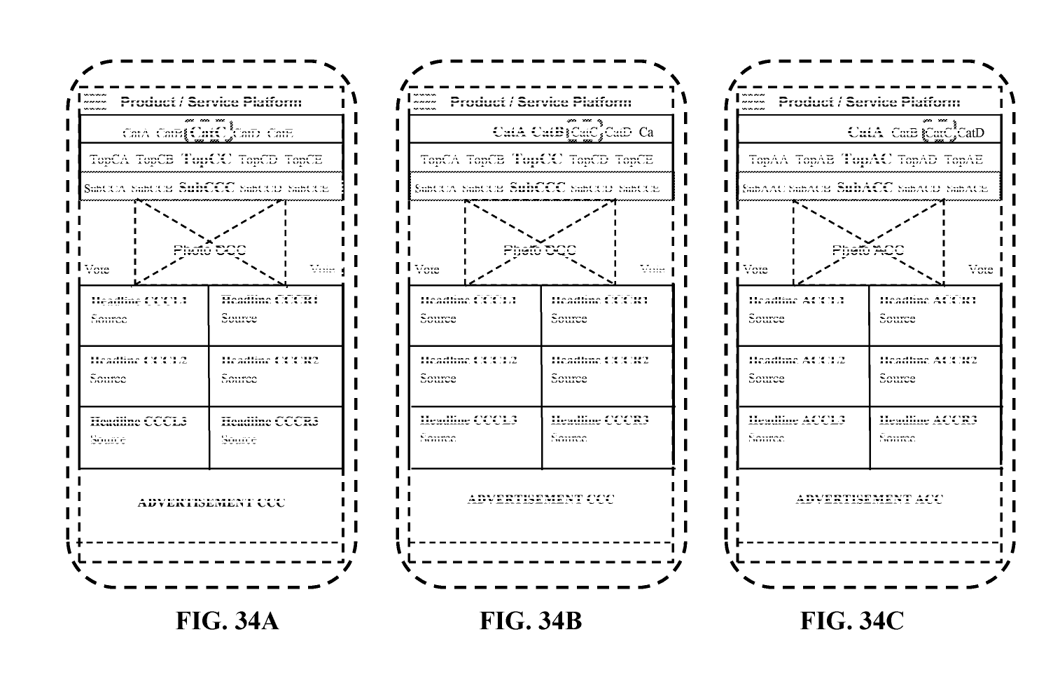

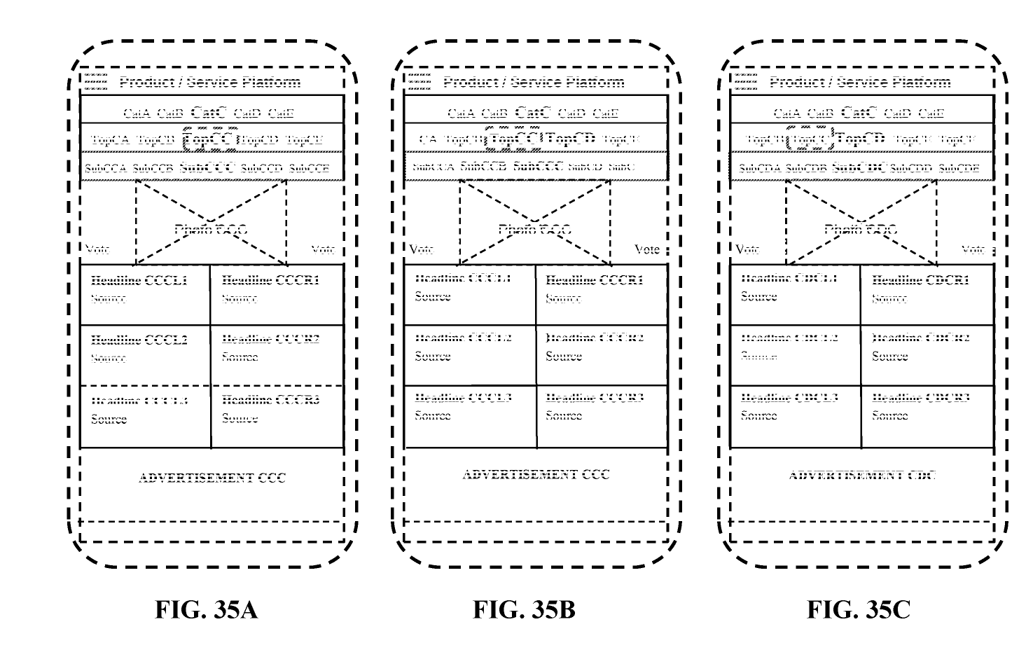

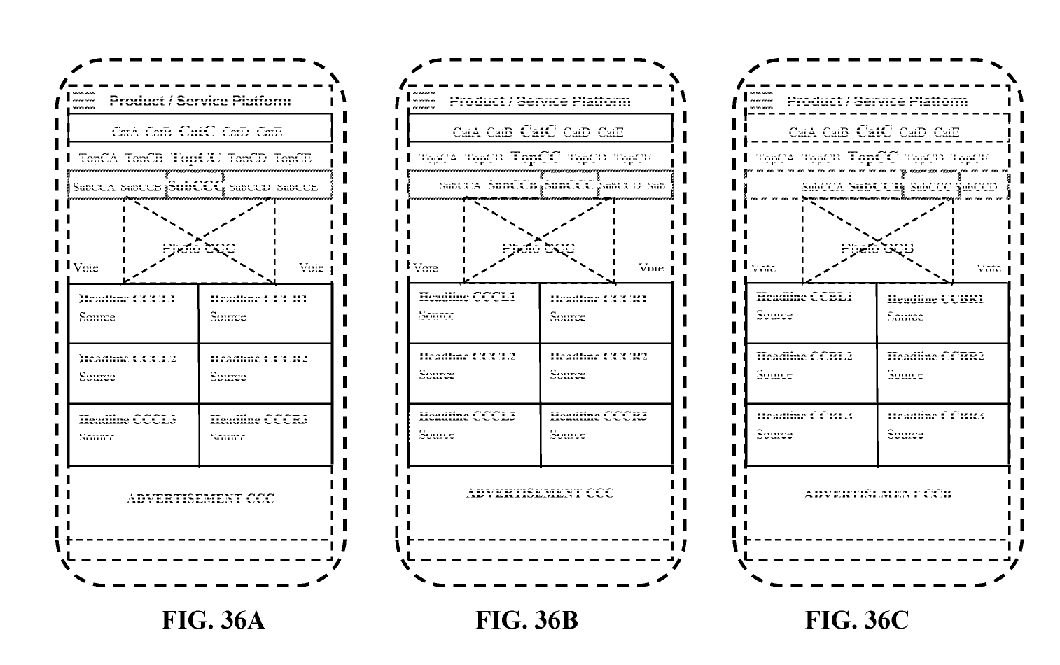

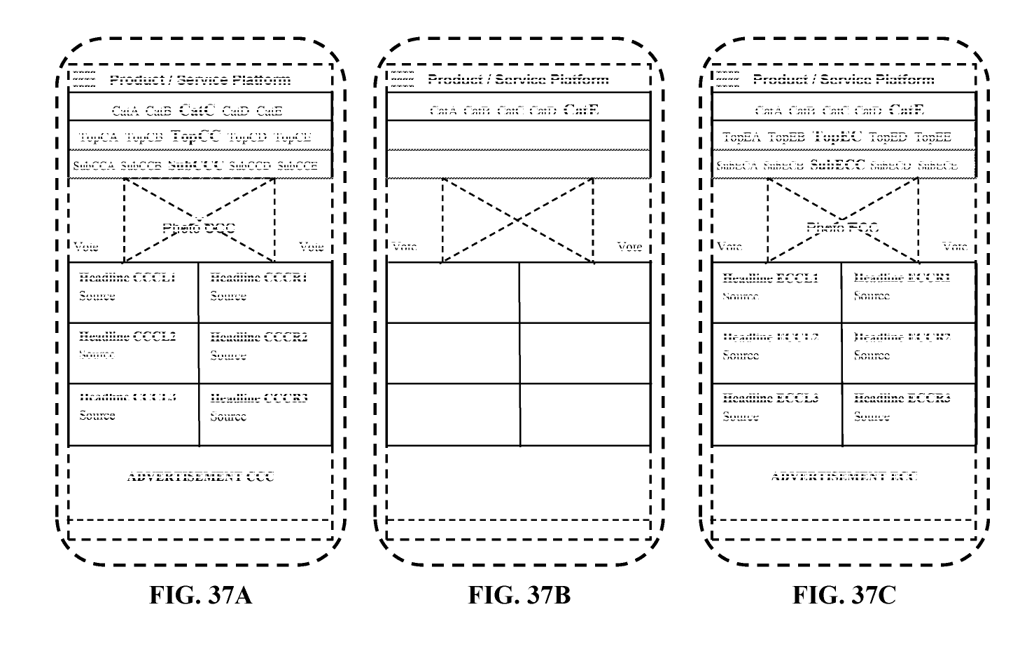

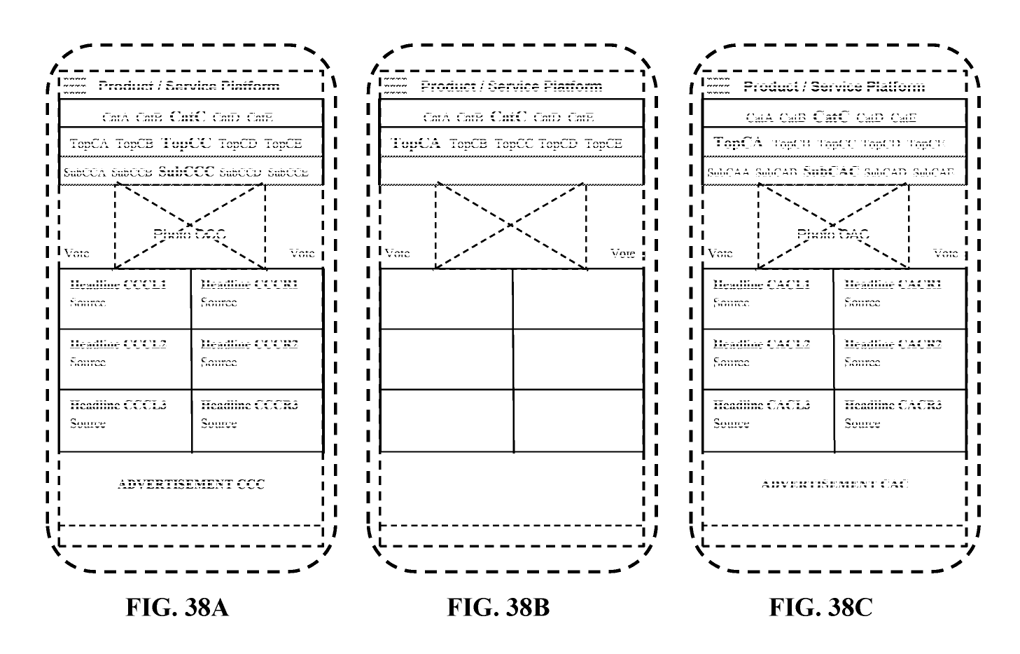

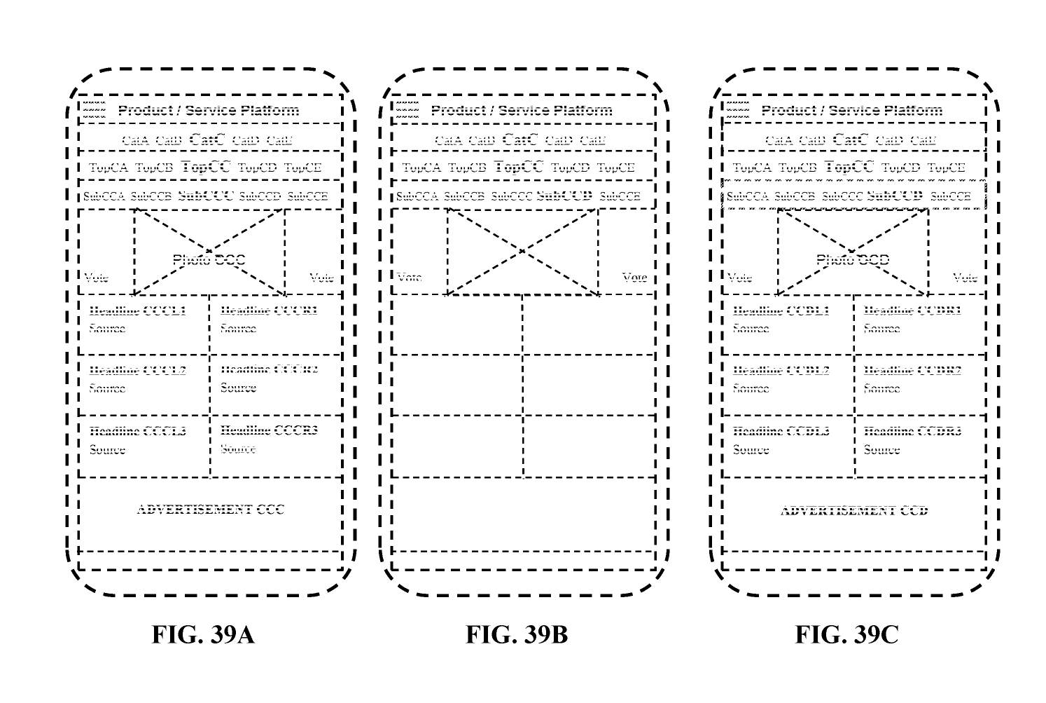

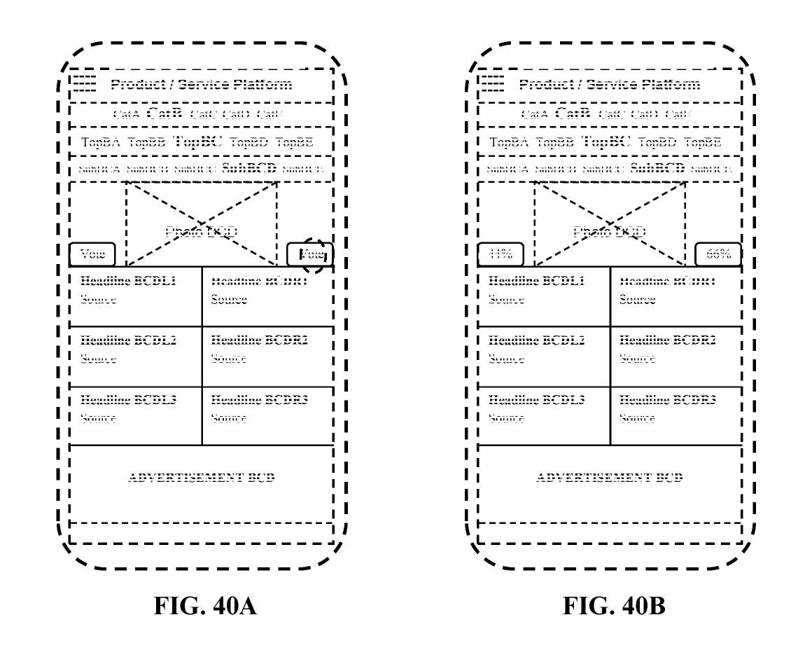

FIGS. 14-40B are screenshots of illustrative alternative interfaces utilized on a mobile device.

### DETAILED DESCRIPTION OF THE DRAWINGS

With regard to FIG. 1A, an illustration of an illustrative news environment 100a in which participants 102 may be the subject of a news story created by observers 104 is shown. The participants 102 may be politicians, sports teams and players, celebrities, criminals, events (e.g., weather events, natural events, terrorist events, etc.), or any other participants that are subject to news stories. The observers 104 may be media 106a-106n (collectively 106). The media 106 may have a point-of-view 108 of an observer looking at the participants 102, as opposed to a point-of-view of the participants looking at one another.

The media 106a may have a first bias 110a, while the media 106n may have a second, opposing bias 110b (collectively opposing biases 110). In one embodiment, if the participants 102 are politicians, then the first bias 110a may be a liberal or “left-leaning” bias, while the opposing, second bias 110b may be a conservative or “right-leaning” bias. In an alternative embodiment, if the participants 102 are sports teams, then the biases 110a and 110b may be toward respective cities of the opposing teams. Still yet, in the case of the participants 102 being opposing parties in the litigation, then the biases 110a and 110b may be plaintiff leaning and defendant leaning, respectively. It should be understood that many other examples of participants and biases may be provided in accordance with the principles of the present invention.

As understood in the art, the media 106 creates news stories 112a-112n (collectively 112) that are presented to an audience 114. The news stories 112 may be in any media format, such as text, photographs, video, and audio, and provided to the audience 114 via any medium, such as printed publication, radio, television, Internet, or any other medium, as understood in the art. Because the news stories 112a and 112n have biases 110a and 110b, the portion of the audience 114 that share similar respective biases 110a and 110b may access the news stories 112 to which each portion of the audience leans toward. However, a certain segment of the audience 114 may desire to access the news stories 112 in a manner that the news stories 112 with the biases 110a and 110b are simultaneously displayed or available to the members of the audience 114 so that the members can view content in an impartial manner.

In accordance with the principles of the present invention, news stories 112a′-112n′ (collectively 112′), which may be the same as news stories 112, but possibly with a different format, may be distributed to a story matching service 116. The story matching service may be configured to match news stories with the same topics and subjects, but having opposing biases 110a and 110b. The story matching service 116 may identify biases 110a and 110b, organize, and communicate the matching news stories 112a′ and 112n′ to the audience 114 via any medium, including the Internet or mobile networks, as understood in the art. Moreover, by the news stories 112′ being organized in a manner that identifies the biases 110a and 110b of each of the news stories 112′, the audience can view the news stories 112′ any more discerning way.

It should be understood that the same topic and subject for different news stories may mean that each of the respective news stories that are being matched may include the same topic and subject, but also include other topics and/or subjects as news stories often have varying focuses within a single news story. In other words, identifying news stories with opposing biases 110a and 110b may be imprecise due to the nature of news reporting, but include at least one sentence that shows a bias toward the same topic and subject.

With regard to FIG. 1B, an illustration of a more detailed illustrative news environment 100b of the new environment 100a of FIG. 1A in which participants may be the subject of a news story created by observers is shown. As shown, the participants 102 may include multiple levels, level 1-level N, of participants, where level 1 may be a lowest level participant (e.g., ball player), level 2 may be a next higher level participant (e.g., manager), and level N may be a highest level participant (e.g., owner). An alternative example would be that of a government worker (e.g., level 1) to President of the United States (e.g., level N).

As further shown, each of the participants 102 at each of the levels may have points-of-views 118a and 118b (collectively 118) towards each of the other respective participants 102 as well as toward the observers 104. Such points-of-view 118 may be utilized to assess a news story so as to determine relationships with other news stories, for example, as well as when the participants become authors of news stories (e.g., letter to the editor, speaker during an interview, etc.).

The media 106 is also shown to include different media types, including (i) traditional media 120a, (ii) new media 120b, and (iii) layman 120c. Traditional media 120a may be an organization that includes organizational structure as well as oversight for each news reporter so as to filter news stories prior to being published. New media 120b may be considered bloggers or other solo, for the most part, generators of news stories and other content. Layman 120c may be considered a citizen journalist who may or may not be a participant and part of a news story (e.g., one armed citizen in a war zone). By distinguishing different types of media 106, the principles of the present invention may organize and match news stories 112′ in a more desirable manner for the audience 114.

The audience 114 is shown to include two audience segments, including a first audience segment 114a-114m and second audience segment 114n-114z. As a political example, the first audience segment may be a liberal or “left-leaning” audience segment, while the second audience segment may be a conservative or “right-leaning” audience segment. Between the two audience segments may be a third audience segment that considers themselves or desires to be unbiased, and is open to or desirous of viewing unbiased news stories. As a sports example, the first audience segment may have a Red Sox bias, while the second audience segment may have a New York Yankee bias. Between the two sports team fans may be a third audience segment that simply likes to watch the rivalry and is open to and desirous of viewing unbiased media. However, even though the third audience segment may be more inclined to want to view news stories or broadcasts of a ballgame, for example, without a particular bias, it should also be understood that audiences with a bias, even a strong bias, may want to view news stories with an opposing bias—even if just to learn what the other bias is reporting.

Even though it is understood that the news media 106a and 106b may have opposing biases 110, the principles of the present invention may further provide for degrees of bias 122a and 122b (collectively 122) that may be utilized to establish a particular degree of bias of the media 106a and 106b, respectively. As shown, the degree of bias 122a may range from DB_{A} to DB_{B}, while the degree of bias 122b may range from DB_{A}′ to DB_{B}′, where DB_{A} and DBA′ may be at a “zero” bias, and DB_{B} and DB_{B}′ may be at opposing extreme biases (e.g., radical left and radical right in a political context).

Further shown are positive (POS) and negative (NEG) indicators at each of the media types 120. The positive and negative indicators are meant to provide an additional parameter of the news media, including each journalist of each media type. As an example, a journalist of the stock market may be “bullish” (i.e., positive) or “bearish” (i.e., negative), so having such a parameter may enable the story matching service to further refine matching of news stories with opposing biases 110.

Along with the new stories 112′, story parameters 124 may be communicated and/or determined by the story matching service 116. The story parameters 124 may include, but are not limited to the story parameters provided in TABLE I. The story parameters 124 may be utilized for matching news stories in an automated or semi-automated manner, as further presented herein.

TABLE I
Story Parameters

| Topic | POV | Participant Level |
|---|---|---|
| Subject | Bias | Observer |
| Content | Bias Degree | Observer Type |
| Source | POS/NEG | Trend |
| Author | Participant | Etc. |

The story matching service 116 may operate to create a user interface 126 inclusive of multiple regions 128, where pairs of the regions are established for presenting news stories with opposing biases 110. The user interface 126 may be accessible via a website, mobile app, television channel(s), radio channel(s), or any other medium.

With regard to FIG. 2, a screenshot of an illustrative user interface 200 that provides for media content to be presented to a user in an organized manner, such as separating the content according to bias, is shown. The user interface 200 may provide an aggregated and organized view of news stories from multiple news source types (e.g., traditional media and new media) and organized by bias so that users may more readily know and select a bias news story that he or she desires. In one embodiment, the news stories may be organized and listed irrespective of media type or degree of bias. In an alternative embodiment, the news stories may be organized by media type, degree of bias, or any other story parameter, as previously described.

The user interface 200 may include a selectable tabs section 202 in which category tabs 202a-202n (collectively 202) may be available for a user to select a category of interest. A selected category indicator 204 may be shown along with a set of topic indicators 206 of the selected category (e.g., politics). The topic indicator 206, as shown, is “scandals,” but any other topic associated with politics may be presented. It should be understood that the set of topic indicators 206 may include one or more, where additional topic indicators may be listed. As an example, political topic indicators may include “environment,” “climate change,” “fracking,” “green energy,” “presidential nominations,” “budgets,” “healthcare,” “foreign policy,” and so on.

Bias identifiers 207a and 207b may be displayed for the user to know the biases that are being presented. The biases of news stories may be automatically determined, manually determined, determined in response to reader feedback, established by the source and author, or otherwise. It should be understood that multiple pairs of biases may be selectably available for a single category and/or topic. For example, for politics, a pair of opposing biases may include “liberal” and “conservative.” Another pair of opposing biases may include “Democrat” and “Republican.” Still yet, if the politics are focused on an election, then the opposing biases may be “first candidate” and “second candidate.” It should be understood that the opposing pairs of biases may be virtually unlimited, but that the use of opposing biases may assist the reader to understand biases of the news sources and authors.

Subject identifiers 208a, 208b, and 208c (collectively 208) may be displayed so that the user can quickly identify subjects within the topic of content associated with content links 210a-210f (collectively 210). Using the selected category and topic(s) for organization, the user interface 200 may include a set of list liberal biased content in a first region, such as a left side, while a set of conservative biased content may be presented in a second region, such as a right side. As an example, within the politics category, scandals topic, IRS scandal subject, and liberal bias may present a set of content links 212a and 212b along with respective source and author identifiers 214a and 214b, and associated with the conservative bias may present a set of content links 212c and 212d along with respective source and author identifiers 214c and 214d so that a viewer knows the source and author of content (not shown). In one embodiment, a bias indicator (not shown) may also be listed along with the source and author indicators, where the bias indicator may be a bias degree indicator based on the associated news story and/or historical news stories published by the source and author, as further described herein.

The topics and subjects presented may be manually, semi-automatically, or fully automatically selected and presented in response to trending data being determined. The trending data may include a rate of news stories being generated by observers that include topics and/or subjects within each category. The rate of the news stories being generated may be determined from sources with one or multiple biases. For example, trending data of a topic and subject from one side of the political spectrum may be significant, while the same trending data of a topic and subject from the other side of the political spectrum may be minimal. Such unbalanced trending of topics and subjects is common for political stories because one side may want to take advantage of a political news story, while the other side may want to minimize the significance of the political news story. Each of the category tabs 202 may provide the same or similar organization on the user interface 200 with category indicator 204, topic identifier 206, bias identifiers 207, and subject identifiers 208 with content identifiers, such as headlines of news stories, being selectably available for a user to view associated content. It should be understood that more than one topic may be displayed with one or more subjects associated therewith.

Rather than simply listing the topics and categories in an unselectable manner as shown, one or more levels of tabs beneath the category tabs section 202 may provide a listing of each of the topics associated with each of the categories, where the listing of topics for each category may change in response to a user selecting a particular category. Additionally, tabs for subjects associated with each of the topics may be created in response to a user selecting a topic. Alternatively, any other user interface feature, such as a pull-down menu, may be available for a user to select topics and/or subjects of categories.

With regard to FIG. 3, a screenshot of an illustrative user interface 300 that provides for media content to be presented to a user in an organized manner, such as separating the content according to bias, along with matching media types and bias degrees is shown. The user interface 300 differs from the user interface 200 of FIG. 2 by providing for matching additional story parameters. The matching may provide additional “visibility” of media bias for users.

As with FIG. 2, the user interface 300 may include a selectable tabs section 302 in which category tabs 302a-302n (collectively 302) may be available for a user to select a category of interest. A selected category indicator 304 may be shown along with a set of topic indicators 306 of the selected category (e.g., sports). The topic indicator 306a, as shown, is “pitching,” and topic indicator 306b is “Game 4,” but any other topic associated with sports may be presented. It should be understood that the set of topic indicators 306 may include one or more, where additional topic indicators may be listed.

Bias identifiers 307a and 307b (collectively 307) may be displayed for the user to know the biases that are being presented. As previously described, the biases of news stories may be automatically determined, manually determined, determined in response to reader feedback, established by the source and author, or otherwise. The pair of bias identifiers 307 is shown as “Red Sox” and “Cubs.” However, the pair of bias identifiers 307 may be any other team or opposing bias, such as “Boston” and “Chicago,” “American League” and “National League,” or otherwise.

Subject identifiers 308a and 308b (collectively 308) may be displayed so that the user can quickly identify subjects of interest. Included within each subject are a traditional media section 310a, new media section 310b, and layman section 310c (collectively 310). Each of the sections 310 may have one or more matching sets of content links, such as matching set of content links 312a-312b (collectively 312) in traditional media section 310a, matching set of content links 314a and 314b (collectively 314) in new media section 310b, and 316a in layman section 310c. Each of the matching sets of content links 312, 314, and 316a may be matched using one or more story parameters, as previously described. In one embodiment, each content link may have an associated source, author, and bias indicator (e.g., bias 5), where the bias indicator may be a bias degree based on the associated news story and/or historical news stories published by the source and author, as further described herein. In one embodiment, a bias degree may range from a value of 0, which means no perceived bias, to a value of 5, which is a maximum bias degree. Depending on the category (e.g., politics), a journalist is supposed to have a bias degree value of 0, while a commentator or opinion writer often has a degree of bias—some more than others. It should be understood that a wider range of bias or alternative bias ratings, such as letters A-F, may be utilized in accordance with the principles of the present invention.

Those commentators or opinion writers with strong bias are often called “far left,” “far right,” “ultra liberal,” “ultra conservative,” and many other terms that are meant to “paint” those commentators or opinion writers as extremists so as to cause “centrists” in an audience to disqualify the thoughts and opinions of those “extremist” commentators or opinion writers. In matching the stories, so as to be intellectually fair, the principles of the present invention may attempt to match as many of the story parameters as possible, especially the degree of bias parameter, so that an unbiased (i.e., degree of bias value equal to 0) news story is not matched up to a heavily biased news story (e.g., degree of bias value equal to 5). By maintain a bias balance between matched news stories, readers can better see and/or hear how media on both sides are attempting to influence the reader and enable the reader to make their own judgment.

As will be provided further herein, the principles of the present invention may enable readers to provide feedback of their assessment of story parameters and which news story is more credible or persuasive. In one embodiment, the feedback may be utilized in matching stories with one another. For example, if an automated system determines that an news story has a degree of bias of 2, but readers determine that the degree of bias is a 4, then the degree of bias may be increased, which would cause the system and/or editor to adjust a matching news story from one with an opposing bias having a degree of bias of 2 to a news story having a degree of bias of 4, for example.

With regard to FIG. 4, a screenshot of an illustrative user interface 400 that provides for an alternative view of organizing opposing biased media content to be presented to a user in an organized manner using a hierarchical structure. As shown, a set of tabs 402a-402n (collectively 402) includes a set of categories that may be selected from a user. In response to selecting a tabbed category, a set of topics 404a-404n (collectively 404) and corresponding sets of subjects 406a-406n (collectively 406) may be selectably displayed for a user. Upon visiting the user interface 400, which may be a website, mobile app, television channel, or other media interface, a category, such as “Politics,” may be defaulted for the user and the topic(s) and subject(s) may be displayed for the user. In one embodiment, only topics may be displayed and a user may selectably “drill down” from the topic to display subjects within a topic. It should be understood that sub-topics, sub-subjects, or any other hierarchical terminology may be utilized for the user interface 400 in assisting a user to access categories, topics, subjects, and ultimately media with opposing bias.

As shown, the opposing bias identifiers 408a and 408b for a “Politics” category is “Liberal” and “Conservative” on the left and right sides of the user interface 400. It should be understood that alternative opposing biases related to politics, such as “Democrat” and “Republican,” may be utilized. Moreover, a user may select a point-of-view, such as “party members,” “television media,” “newspapers,” or any other point-of-view.

The topics and subjects within each topic may be determined by a process that monitors trending topics and subjects, as further described herein. As shown in relation to each topic and subject are graphical expansion elements 410a-410n that enables a user to selectably expand and collapse the respective topic and subject to show subjects within topics 404 and media (not shown) within subjects 406. As subjects 406 are expanded, media may be displayed in opposing bias relation beneath the respective opposing bias identifiers 408, such as that shown in FIG. 3.

With regard to FIG. 5, another screenshot of an illustrative user interface 500 that provides for another alternative view of organizing opposing biased media content to be presented to a user in an organized manner using a hierarchical tab structure 502 to easily enable users to “drill down” from categories to topics to subjects of information that he or she desires to view is shown. The hierarchical tab structure 502 may include a set of category tabs 504, set of topic tabs 506, and set of subject tabs 508. In response to a user selecting a category, such as “politics,” from the category tabs 504, a set of topics may be used to populate the set of topic tabs 506. The user may thereafter be able to select a topic, such as “scandals,” from the set of topic tabs 506. In response to the user selecting a topic, a set of subjects may be used to populate the set of subject tabs 508. In response to the user selecting a subject from the set of topic tabs 508, media 510 may be displayed in opposing bias relation beneath the respective bias identifiers 512a and 512b (collectively 512). The media 510 in this case are content links to articles. However, it should be understood that the media may additionally and/or alternatively be links to video, audio, or any combination thereof. As shown, the media may present source and author identifiers in association with each of the content links so as to enable a user to know the source of the media. Other identifiers, such as bias degree automatically or subjectively selected, user ratings, user determined bias degree, or otherwise, may be displayed in association with each content link. Rather than simply showing a content link, which may be a headline, an abstract or opening text (e.g., one or more sentences) may be displayed along with the content link to provide the user with additional information about the content link. Still yet, an image may be associated with a content link to further illustrate to the user the nature of the content.

In one embodiment, the media 510 may be configured in media-type sets, including traditional media 514a, new media 514b, and other media-type sets, such as layman and/or otherwise. In accordance with the principles of the present invention, one or more content links may be displayed in each of the media type sets 514a and 514b. In one embodiment, the content links may be arranged in descending or ascending order from highest degree of bias to lowest degree of bias. In another embodiment, the content links may no be arranged in any particular order. The user may be provided with the ability to define how he or she wants the content links ordered in terms of degree of bias. As previously described, the media may be arranged such that content links with opposing degrees of bias (e.g., +5 and −5, where +5 is most liberal and −5 is most conservative) are aligned on the left and right sides of the screen. Each of the media-type sets 514 may include a “more” soft-button 516 that enables a user to view additional content links available within the respective category>topic>subject>bias>media type.

In one embodiment, the sets of topics and subjects are automatically generated and positioned based on trending of topics and subjects of respective categories. That is, the principles of the present invention may provide for tracking new articles and other content, and, as certain news articles and other content become more reported, those topics and subjects of higher trending may be presented in a higher order than lesser trending topics. In an alternative embodiment, the sets of topics and subjects may be semi-automatically generated and positioned by the principles of the present invention automatically identifying trending of topics and subjects, but enable a user to set positioning of those topics and/or subjects. The principles of the present invention may further provide for automatic adjustment based on subject and topics that are selected by users of the user interface 500, and the automatic adjustment may occur periodically (e.g., once per day, once every 4 hours) or aperiodically (e.g., responsive to news stories crossing a threshold or surpassing one another in terms of stories being generated and/or accessed).

With regard to FIG. 6, a screen shot of an illustrative user interface 600 in which a video or graphical image 602 is displayed in this case a sporting event (e.g., baseball game), for example. As shown, two audio feed soft-buttons 604a and 604b may be available to a user to select an audio feed from which to listen. The two audio feeds may have bias for respective teams, in this case Red Sox and Yankees. During a sporting event, it may be of interest for sports fans of either team to want to listen to sports announcers that are biased for and against their team. Moreover, topics 606a and 606b with associated subjects 608a and 608b may be presented to a user to select to view articles from traditional or other media sources (e.g., bloggers). The topics and subjects on respective sides of the graphical user interface 600 may be biased for respective teams (e.g., Red Sox and Yankees). Selection of a topic and/or subject may cause articles to be presented to the user. It should be understood that alternative user interfaces that make available information with respective bias. As previously described, articles or other media with opposing degrees of bias may be positioned opposed to one another. It should be understood that other categories other than sports, such as political debates, news coverage, or otherwise, may be presented to a user with selectable audio feeds for the desired bias. In one embodiment, rather than simply having a bias for respective teams (or candidates), multiple biases for each team (or candidate) may be selectable, where the multiple biases may have different degrees of bias (e.g., sports commentator who is more biased for a team than a sports commentator who tries to be more neutral, such as a national sports commentator than a local market sports commentator).

With regard to FIG. 7A, a screen shot of an illustrative user interface 700a is shown to include a set of category tabs 702a-702n (collectively 702) inclusive of selectable categories, such as “politics,” “world,” “US,” “sports,” etc. A category indicator 704 indicative of the selected category, in this case “politics,” may be used to indicate to a user which of the tabs 702 is selected. As previously described, each of the categories may have selectable topics (not shown) that the user may select to view. As shown a topic indicator 706, in this case “scandals,” may be displayed to indicate to the user which of the topics has been selected. Each of the topics may also have selectable subjects (not shown) for the user to select. A subject indicator 708 may be displayed to indicate to the user which subject, in this case “IRS scandal,” has been selected. Two bias indicators 710a and 710b, in this case “liberal” and “conservative,” may be displayed to indicate to the user the biases of which content links 712a and 712b (collectively 712) are aligned (e.g., liberal or conservative bias content).

To provide for reader feedback about content bias, each content link may have a “rate bias” selector element 714a and 714b that enables the user to select a bias level, where a 0 bias is no bias and a 5 bias is a high bias. By providing users with the ability to select a bias level for each story, the principles of the present invention may provide for aligning the content links 712a and 712b with content links that have opposing bias levels (e.g., liberal 4, conservative 4) based on the user feedback. In one embodiment, the a “vote” soft-button 716 may enable the user to select to vote or otherwise provide feedback related to the content provided by the content links 712, as provided in FIG. 7B. In an alternative embodiment, voting may be performed in relation to the content links 712.

With regard to FIG. 7B, a user interface 700b may display the content links 712 or indicia, such as headlines, images, etc., associated with the respective content links 712 along with illustrative questions of which a user may answer to rate content or otherwise provide user-submitted information or feedback for the content associated with the content link. Multiple questions 718a, 718b, 718c, and 718d (collectively 718) and respective graphical user selection elements 720a, 720b, 720c, and 720d. The results of the votes may be used to show users or users who vote sentiments of other users or users who voted. The questions 718 may be generic questions or may be specific questions related to the content in the content links 712. In one embodiment, the feedback of the questions 718 may be used to match content with content having opposing bias ratings. The answers to the questions may also be used for polling or any other information, as understood in the art.

With regard to FIG. 8, a screen shot of an illustrative user interface 800 provides for an editor to select categories, topics, and subjects along biases, such as liberal and conservative, is shown. Each of the topics may be sorted by bias and subject within each topic, and a total number of available stories of each subject that are available may be listed in association with one another. In one embodiment, the number of articles available from which the editor may select may be automatically generated and organized for the editor. In one embodiment, an automated process using an RDF triples algorithm, where a computing system may identify subject, predicate, object of sentences within an article may be utilized to determine categories, topics, and subjects within an article or other source content (e.g., video interview). Moreover, other techniques, such as ontology models, to determine bias, bias level, point-of-view, etc., may be utilized. The ontology models may be pre-configured to determine one or more of bias, bias level, point-of-view, etc. An editor (i.e., human) may use the editing tool to select, post, match with opposite bias and bias level, etc. In one embodiment, those selections may be performed automatically or semi-automatically and the editor may simply review and confirm prior to publishing. In one embodiment, the information presented to the editor may be posted based on trending data, such as how many stories have been written, rate of new stories, etc. In one embodiment, trending may be tracked based on geography, such as local, regional, national, and/or international developing stories.

With regard to FIG. 9, a screen shot of illustrative trending data that allows for an editor and/or user to view how certain news stories (or other types of events and issues) are trending is shown.

With regard to FIG. 10, a screen shot of an illustrative editor user interface that allows for an editor to select and set and create information to be displayed for users to view is shown.

With regard to FIG. 11, a network environment in which information may be collected and distributed to an audience is shown. The information, as provided hereinbefore, may be organized in a manner that multiple biases (e.g., liberal and conservative) may be collected, identified based on story parameters (see FIG. 1B), organized, and presented to a user or viewer of a website, mobile site, mobile app, television channel, radio channel, or any other form of media that is capable for a user to selectively view and/or listen to stories with opposing biases.

To improve efficiency of network and memory resources for content delivery, the principles of the present invention may provide for content delivery functionality that controls content flow based on historical information of a user, statistical information of content being viewed, or otherwise to present to users. For example, if a user typically looks at liberal biased content, then that content may be delivered to an electronic device (e.g., mobile device, such as a tablet) of a user in full, which other content, such as opposing bias content, may be delivered in part or not delivered at all and wait for a user to select a link to that content. In another embodiment, certain predicted desired content by a user, such as conservative content, that is to be viewed by a user, such as streaming video, may be delivered using a high bandwidth, which content that the system anticipates not to be accessed by the user may be streamed at a lower bandwidth, so that the data communications channel has less content being delivered to a user. However, by streaming content to a user, albeit a different streaming rates, less network and memory resources may be utilized, while providing the user with the ability to instantaneously have access to the content without lag. That is, if information that is not expected to be listed to, in the case of audio content, is being streamed that is an opposing bias from content have a bias to which a user is listening, then the user may switch to the opposing bias and be able to listen without having to wait, thereby improving the experience of the user. Such a process may be considered a “shadow” process, where the shadow content is available to a user, and upon selection of that content, the data rates, for example, may be altered to increase the content with the lower data rate to a higher data rate, and vice versa. The same or analogous functionality applies to data and video. In one embodiment, quality of service (QoS) may be different for data that a user is expected to view or actually viewing versus data that the user is not expected to view or is not viewing, where expectation may be based on historical preferences and actions by a user.

To provide for such functionality, the content may be provided from a head-end server to local servers using similar functionality. Moreover, as trending data changes, so too may the communication and storage of that trending data. For example, as trending data begins to increase, so too may the communication of that data to be closer to end-users. The trending data may be local, regional, national, or international in nature and be communicated in that manner, such that local news stories that are of interest in one region may not be communicated to that local region, but not to all local regions. And, as trending of content decreases, that content may be moved from a primary memory or channel to a secondary memory or channel, thereby improving efficiency of memories and communications paths. The system may cache information (e.g., news stories) based on history of a user or group of users.

With regard to FIG. 12, screen shots of illustrative user interfaces utilized on a mobile device to present information, such as headlines, associated with news stories (or other content) for a user selectably read content of the news stories by selecting (e.g., sliding) a headline of respective information is shown. In the center screen shot, a user may be presented with one or more rows of selectable options in which categories, topics, and subjects are available for a user to select. In this case, a top row includes categories, a second row includes topics of a selected category, and bottom row includes subjects of a selected topic of a selected category. The rows are considered to include selectable control elements that allows a user to control headlines presented to the user, as shown. In one embodiment, selection of any of the categories, topics, or subjects may cause a set of headlines, in this case three sets of headlines, of a selected category, topic, and subject (e.g., Politics, Economy, Jobs) to be transitioned to be displayed. The transition may be smooth (e.g., slide, fade, etc.) or be abrupt (e.g., remove one set of headlines and replace with another in an immediate transition manner).

In one embodiment, the rows may be configured to “rotate” or “slide” the selected category, topic, and/or subject by a user placing his or her finger on the row and sliding the finger left or right, thereby causing the words to “rotate” left or right in a continuous manner. As the words of any or all of the rows are rotating left or right, the headlines and, optionally, advertisement, may also rotate left or right to match the updated category, topic, and subject. It should be understood that if the user selects a different category, the topic and subject changes to match the category (e.g., changing from politics to sports causes the topics and subjects to change from politics to sports). It should also be understood that if the user changes the topic, the category will remain the same, but the subject will change. Still yet, if the user changes the subject, the category and topic will remain the same. The synchronization or coordination of the control elements (i.e., categories, topics, and subjects) may be performed by storing a last previously viewed (category, topic, subject) set, which enables a viewers to view that previous combination if he or she switches category and/or topic. For example, if a category, topic, subject set is (C, B, D), and the user selects a new category, such as category A, then the category, topic, subject set may be set to a previous selection category, topic, subject set of which the user had viewed, such as (A, D, B). In an alternative embodiment, rather than storing the previous sets of control elements, the user interface may simply maintain current selection positions. For example, if a category, topic, subject set is (C, B, D), and the user selects a new category, such as category A, then the category, topic, subject set may be set to (A, B, D). It is anticipated that the categories will remain the same, but that topics and subjects will vary based on news cycle or other events. If the topics and/or subject vary, then historical viewing data will be meaningless, and the user interface may be set the topic and/or subject to a center position topic and/or subject or any other position(s) (e.g., current positions of selected topic and/or subject) based on whether the user selects a new category or topic.

The user interfaces on the left and right screen shots are shown to include content associated with a selected headline. The user interface may enable the user to tap a headline (or region in which the headline is positioned), and the content may instantly appear to replace the user interface of the center screen shot. Alternatively, in accordance with touch screen displays, if the user slides his or her finger on a story on the left side to the right (or vice versa), the story will be “pulled into” the display to replace the user interface of the center screen shot. In one embodiment, the stories that are “pulled into” the display may be included in a frame of the mobile site. Alternatively, the story may be displayed as presented on another source's website, such as a mobile website.

Voting buttons (not shown) may be presented to the user to select which side of the subject he or she agrees, and, responsive to voting, voting results may be presented (e.g., 36% agreed with the stories having biases presented on the left side of the display and 64% agreed with the stories having biases presented on the right side of the display). In one embodiment, a software module being executed to provide for the voting may be configured to receive and store current voting values of each combination of category, topic, subject combination from a server, and, responsive to a user selecting a voting button (i.e., to vote for which of the two sides of a selected category, topic, subject he or she agrees), display or include the user's vote and display current voting statistics. In addition, the software module may communicate the vote back to the server to include the user's vote for inclusion in a current vote for the respective category, topic, subject, thereby enabling the current vote to be communicated to other users. In one embodiment, a Java script element may be used to support the voting buttons associated with the category, topic, subjects and feedback of vote(s) made by a user. Alternative configurations may be utilized, as well.

FIGS. 13A-13D are screen shots of illustrative alternative configurations of user interfaces utilized on a mobile device. FIG. 13A shows that the rows of categories, topics, and subject include selectable words for a user to select. In this case, the words are not rotatable, but a button (not shown) may allow additional words to be presented to the user. As shown, the user changes from viewing CatC, TopC, SubjC to CatC, TopC, SubjD by selecting SubjD. In response, the photo, headlines, and advertisement may change to match the selected category, topic, and subject. FIG. 13B is shown with rows of categories, topics, and subject that are rotatable that allows for a user to rotate any of the rows and the corresponding rows will remain fixed or rotate (e.g., rotating the category causes the topics and subjects to change to match the category). The user interface may remember the topics and subjects selected the previous time that a category was viewed. As shown, the user has selectably changed each of the category, topic, and subject from CatC, TopC, SubjC to CatA, TopA, SubjD, and the corresponding content (e.g., photo, headlines, and advertisement) is also changed. Again, the user interface may rotate the content in as the user rotates the rows or abruptly change the content. As shown “vote” buttons allow for the user to vote for whether he or she agrees with the left or right stories of a category, topic, subject, and, responsive to voting, results of all votes may be displayed, thereby engaging the user with content in a more profound manner than conventionally possible.

With regard to FIGS. 13C and 13D, screenshots of illustrative user interfaces are slightly different from those of FIGS. 13A and 13B, where in FIG. 13C, one category and topic are selected, and the user is able to scroll down to view each of the subjects of a selected category and topic. It should be understood that multiple categories and topics may be listed in each of the rows and that the subjects are listed vertically. In FIG. 13D, the categories are selectable within a row (or the row can be swiped left or right to view a different category) and the topics and subjects within the category are vertically displayed so that the user can scroll up and down to view the headlines of all topics and subjects of the category. Advertisements may be listed between topics or subjects or in any other manner, as understood in the art. Tables I, II, and III below represent the structure of the user interfaces of FIGS. 13D, 13C, and 13A/13B, respectively. As provided by FIGS. 13A-13D and the tables, the user interface may be varied to make the user interfaces more “horizontal” or “vertical” depending on how the category, topic, and subject rows are configured and interrelate with the content being displayed.

TABLE I
Vertical Topic Configuration

| Category A | Category B | Category C | . . . | Category N |
|---|---|---|---|---|
| Topic A | Topic A | Topic A | . . . | Topic A |
| Subject A | Subject A | Subject A | . . . | Subject A |
| . . . | . . . | . . . | . . . | . . . |
| Subject N | Subject N | Subject N | . . . | Subject N |
| AD A | AD A | AD A | . . . | AD A |
| Topic B | Topic B | Topic B | . . . | Topic B |
| Subject A | Subject A | Subject A | . . . | Subject A |
| . . . | . . . | . . . | . . . | . . . |
| Subject N | Subject N | Subject N | . . . | Subject N |
| . . . | . . . | . . . | . . . | . . . |
| AD N-1 | AD N-1 | AD N-1 | . . . | AD N-1 |
| Topic N | Topic N | Topic N | . . . | Topic N |
| Subject A | Subject A | Subject A | . . . | Subject A |
| . . . | . . . | . . . | . . . | . . . |
| Subject N | Subject N | Subject N | . . . | Subject N |
| AD N | AD N | AD N | . . . | AD N |

TABLE II
Horizontal Topic Configuration (preferable over vertical)

| | | | |
|---|---|---|---|
| Category A | Category B | . . . | Category N |

| | | | | | | | | |
|---|---|---|---|---|---|---|---|---|
| Topic A | Topic B | . . . | Topic N | Topic A | Topic B | . . . | Topic N | Topic A |
| Subject A | Subject A | . . . | Subject A | Subject A | Subject A | . . . | Subject A | Subject A |
| . . . | . . . | . . . | . . . | . . . | . . . | . . . | . . . | . . . |
| Subject N | Subject N | . . . | Subject N | Subject N | Subject N | . . . | Subject N | Subject N |
| AD A | AD B | . . . | AD N | AD A | AD B | . . . | AD N | AD A |

TABLE III
Horizontal Topic and Subject Configuration (preferable over vertical)

| Category A | | | | Category A | | | | . . . | Category N |
|---|---|---|---|---|---|---|---|---|---|
| Topic A | Topic A | . . . | Topic A | Topic B | Topic B | . . . | Topic B | . . . | Topic A |
| Subject A | Subject B | . . . | Subject N | Subject A | Subject B | . . . | Subject N | . . . | Subject A |
| AD A | AD B | . . . | AD N | AD A | AD B | . . . | AD N | . . . | AD A |
| | | . . . | | | | . . . | | . . . | |
| | | . . . | | | | . . . | | | |

FIGS. 14-40B are screenshots of illustrative alternative interfaces utilized on a mobile device.

In one embodiment, if a mobile device on which the user interface is being presented is capable of collecting geocoordinates using global positioning system (GPS), triangulation, or other geocoordinate identification technique (e.g., function of a mobile browser), that geocoordinate information may be collected so as to determine where a user is viewing the information. By tracking geocoordinates, targeted advertising may be made. In addition, if geocoordinates are collected at nighttime (e.g., 10 pm to 6 am) and a repeated location at night is determined, then a system may determine residences of respective users. By knowing the residence, at a street address level or geopolitical address level (e.g., zip code), the system may determine how many users or viewers are viewing the user interface within a designated market area (DMA) as defined by Nielsen, number of views of the user interface (frequency of view), type of content the users are viewing (e.g., political, left leaning, right leaning, sports, etc.) so that in addition to knowing geocoordinates of the viewers, political or other biases of the viewers may be determined so that more particular advertising may be made to specific viewers or viewers within a geographic region (e.g., DMA).

In addition, as demographics and other information may be available through third-party services, such as Google Analytics, significantly more targeted advertising and content selection and delivery may be made. As an example, if it is determined that a user is a female, approximately 35 years old, has at least one child, is politically liberal, and lives in a suburb of Boston, then advertising that is both geographically local and politically oriented (i.e., liberal biased) may be delivered to the user. Moreover, if the user participates in voting for biases associated with articles, for example, of subjects of which he or she agrees, that information may also assist in determining political, sports, world view, or other biases and causes of which the user cares or agrees. By aggregating viewership by DMAs, media metrics that align with traditional media sources may be determined so that advertising rates may be charged at a premium rather than conventional digital media rates that are typically unable to determine geographic location of residences of users.

The previous description is of a preferred embodiment for implementing the invention, and the scope of the invention should not necessarily be limited by this description. The scope of the present invention is instead defined by the following claims.

What is claimed:

1. A method for presenting content, said method comprising:
selecting, by a processing unit, a first data content and a second data content both having been determined to be related by a same topic and subject, but with opposing biases from a given point-of-view;
causing, by the processing unit, a first identifier associated with the first data content to be displayed to a viewer in a first viewing region of a user interface on an electronic display; and
causing, by the processing unit, a second identifier associated with the second data content to be displayed to the viewer in a second viewing region of the user interface on the electronic display, the first and second identifiers arranged within their respective viewing regions in a manner indicating their opposing bias relationship to the viewer.

2. The method according to claim 1, further comprising enabling, by the processing unit, the first and second identifiers to be selectable.

3. The method according to claim 2, wherein selecting the first and second identifiers includes selecting titles for the respective first and second data content.

4. The method according to claim 2, wherein selecting the titles includes selecting headlines, and selecting the first and second data content includes selecting news stories.

5. The method according to claim 1, further comprising determining biases of the respective first and second data content, wherein the biases are liberal and conservative biases, and wherein the given point-of-view is from a perspective of an observer.

6. The method according to claim 1, wherein the point-of-view is directed to politics, and wherein the different biases include a first bias supportive of a first political party and a second bias supportive of a second political party.

7. The method according to claim 1, wherein the point-of-view is directed to an event, and wherein the different biases include a first bias about the event from a first geographic location and a second bias about the event from a second geographic location.

8. The method according to claim 1, wherein the point-of-view is directed to a sports team, wherein the different biases include a positive bias about the sports team and a negative bias about the sports team.

9. The method according to claim 1, further comprising, by the processing unit, causing topics within a common category to have their respective identifiers displayed within associated viewing regions within the electronic display according to their respective biases.

10. The method according to claim 1, wherein the first and second viewing regions are arranged side-by-side and wherein the first and second identifiers are aligned side-by-side with each other.

11. The method according to claim 1,
wherein the first content is originally in a first language,
wherein the second content is originally in a second language; and
further comprising translating at least one of the languages of the first and second content.

12. The method according to claim 1, further comprising searching, by the processing unit, a plurality of data repositories to identify a content being in a category and topic.

13. The method according to claim 12, further comprising:
analyzing, by the processing unit, the content from a first data repository to identify content having the first point-of-view;
analyzing, by the processing unit, the content from a second data repository to identify content having the second point-of-view.
